(19) United States
(12) Patent Application Publication
(10) Pub. No.: US 2010/0169229 A1
(43) Pub. Date: Jul. 1, 2010

(54) Business Processing System Using Remote PC Control System of Both Direction

(76) Inventor: Jae Chun Lee, Kyoungki-do (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/223,909

(22) PCT Filed: Feb. 7, 2007
(86) PCT No.: PCT/KR2007/000658

§ 371 Date: Aug. 11, 2008

(30) Foreign Application Priority Data
Feb. 9, 2006 (KR) 10-2006-0012411
Apr. 13, 2006 (KR) 10-2006-0033466
Feb. 7, 2007 (KR) 10-2007-0012422

(51) Int. Cl. G06Q 10/00; G06F 15/16

(52) U.S. Cl. 705/301; 709/203; 715/758

(57) ABSTRACT

The present invention relates to an integrated business processing system in which a conventional Internet web server-based unidirectional remote control system can be improved to a bidirectional PC remote control system in a one-to-one PC access state, a variety of functions, such as a table for writing letters and drawing figures, etc., can be added, and a variety of business processing can be smoothly performed through the association of a client PC system, a consultant PC system, a franchise head office system, an assistant business PC system in terms of a business task, a construction site business processing PC system, an custom-built and material development PC system, a company head office warehouse and factory PC system, and a developing country production factory and export/import management PC system, which are based on a unidirectional or bidirectional PC remote control business processing system. To this end, integrated business processing system using a bidirectional PC remote control base, wherein a client PC of an Internet PC remote control system including a PC main body and a general monitor connected to the PC main body, and a consultant PC of the Internet PC remote control system including a PC main body and multiple monitors of a main monitor and an auxiliary monitor having a liquid crystal tablet or a general tablet, which is connected to the PC main body and is capable of performing two or more writing and drawing functions, are connected using communication means of wired/wireless wires or satellite Internet, and a remote control client module, a remote FIP client module and a remote CHAT client module are constructed for the remote control, and are adapted to analyze a corresponding protocol and distribute and transmit each thread through a TCP/IP communication port, wherein the consultant PC first opens a consultant access administrator window of the PC remote control system, displays the consultant access administrator window on the monitor, and informs the client PC of a remote access request using a general telephone, so that the client PC can make access through a client adaptor or an access program through a website; and after a client is accessed through Internet remote control by clicking on a client access menu of the Internet remote control system base, the client PC remotely accesses the client PC and remotely accesses the consultant PC by manipulating the PC main body of the client PC under remote control authority.

### TECHNICAL FIELD

The present invention relates to an integrated business processing system, in which a conventional Internet web server-based unidirectional remote control system is improved to be a bidirectional PC remote control system in a one-to-one PC access state, a variety of functions, such as a tablet function for supporting the writing of letters and the drawing of figures, is added thereto, and various business processes are smoothly performed through the association of a client PC system, a consultant PC system, a franchise head office system, an assistant business PC system in terms of a business task, a construction site business processing PC system, an custom-built and material development PC system, a company head office warehouse and factory PC system, and a developing country production factory and export/import management PC system, based on a unidirectional or bidirectional PC remote control business processing system.

### BACKGROUND ART

As society continues to develop, a variety of businesses, business activities, etc. have become large and specialized. Accordingly, workers conducting such tasks are segregated and perform specialized tasks. Thus, business systems supporting the specialization and increase in size of organizations have been deployed and formed in various fields. In all types of business, there are trade relationships between sellers and buyers and upper and lower levels in terms of business processing. Thus, business organizations deal with and consult with customers, and companies perform various types of interactive business processing internally and externally. Furthermore, in large-sized companies, productivity is improved and business is developed as the business is divided based on individually specialized tasks.

In order to smoothly perform business transactions between two or more persons or a company's business processing in line with the computer era, tasks are performed utilizing computer systems and a Personal Computer (PC) remote control operation system between remotely situated computers. With regard to the prior arts, Korean Patent Application Nos. 10-2001-0068939 (entitled “Improved Internet Remote Control System”), 10-2002-0072969 (entitled “Remote Control System Using Web and Icons”), and 10-2002-0014773 (entitled “File Exchange System through Gateway Server”) are disclosed.

However, in performing shared business processing between two persons or multiple persons, it is best to communicate with each other while writing and drawing figures face-to-face. A PC terminal remote control system using the wired/wireless Internet has been popularized and widely used. For a remote control system for a client PC and a consultant PC based on PC remote control-based remote control via the wired/wireless Internet, three types of unidirectional remote control access schemes have been introduced.

There are many Internet PC unidirectional remote control access system developers and business providers in Korea, such as WWW.RSUP.NET and WWW.PCCONTROL.CO.KR. The access operation and technical contents of the Internet remote access control schemes are classified as follows.

First, when a customer using a client PC consults with a consultant's PC from a remote place, the consultant using the consultant server PC takes the initiative in establishing remote control. Thus, if the customer using a client PC visits a website and subscribes to and accesses a client PC, the consultant's PC terminal accesses the customer's client PC terminal, and then performs a PC remote control function of performing various inquiries while operating the customer PC terminal under remote control authority over the customer PC terminal from a remote place. This is a method that a company uses to deal with a plurality of customers.

Second, the party that takes the initiative between such companies or businesses becomes the PC remote control consultant, and first subscribes a client PC, which is the object of a lower management task, to a PC remote control system as a client PC. The party accesses the client PC terminal from a remote place anytime that the client PC terminal is turned on, if appropriate, and issues task instructions, checks task status or supports business dialogue. This is a method that is used when a mutually dependent and trusting relationship exists between the client PC terminal and the consultant PC, that is, between two parties in the case where a trading relationship between the two parties is trustworthy.

As a third unidirectional remote control system, there is a package type unidirectional remote control operating system, in which PC remote control program operation and development companies supply remote control operation forms from a consultant PC and a client PC, which are customized to be suitable for each company. This is an order-fabricated type unidirectional remote control system method of fabricating the remote control operation forms by inserting the logo of a corresponding company or by modifying them to be suitable for the needs of various companies. That is, this is the third unidirectional remote control operational method of modifying and applying various factors to suit a corresponding company's requirements, such as by inserting only a password into the consultant server PC and omitting a user ID, or providing as many fixed numbers as there are consultant users.

Therefore, the three types of unidirectional remote control systems can be applied to various fields and companies. A typical PC remote control system used in a company is an auxiliary system for corporate business processing, which is generally used in the case where a situation is solved through consultation when a problem related to a customer's computer occurs, or a worker remotely accesses a computer at a remote place and opens or receives materials.

Meanwhile, in view of corporate business processing, a manager, a consultant and various workers are organized together with customers or subdivided into external and internal business processing groups. For effective business processing, the computer is used in all tasks. Specialized computer software for performing a given task is expensive and is legally allowed to be installed on only one computer. Accordingly, since it is illegal to use the program on computers other than the computer used by a worker himself, there have been many problems in which the task program cannot be moved and, therefore, cannot be effectively used by everyone.

In the case of a trading business, in which an order requested by an orderer is produced, such as a product development production task or a computer graphic design task, several task processes must be performed while showing original image materials to the ordering client up to the task completion step. This is a task condition that is unfavorable to the company performing the work because the task is performed while materials being fabricated are transferred even though the task is being performed in a state in which payment for the task has not been made.

A good business transaction process is the task processing and consulting process of retrieving task material while showing it to an orderer. However, a computer task processing consulting process is a method of reducing the original image material to a small image, etc. In this process, if an orderer cancels an order due to a change in plans during the task process of handing the task material over the orderer for review and modification of the task material according to the orderer's instructions, the transaction is stopped without receiving the balance of the task cost, and the orderer does not receive the task materials. Thus, this process is a business processing system that promotes unfair trading.

Only large-sized companies capable of performing large numbers of transactions have a competitive advantage because a large amount of information is temporally processed over regional space on the Internet and a large amount of data and business processes are utilized in real time using a systematic system. In order to rapidly process trading business processes related to the business category in which a company in a corresponding field is active, inexpensively increase the productivity of specialized workers and the quality of work, and increase added value at high efficiency, large-sized companies require rapid, transparent and global business systems, which can process information and perform many tasks based on Internet technology.

It is therefore necessary to develop the personal productivity and production methods of workers, which to date have been business-oriented and conducted based on the technology and capability of a worker, into a large-sized mass distribution corporate configuration based on Internet communication.

Meanwhile, the unidirectional PC remote control system is a unidirectional remote control system in which a consultant using a PC terminal has a business conversation with a client while remotely controlling the client's PC terminal over the Internet and manipulating and operating the client's PC terminal. The best business processing or business transaction processing situation is one in which two parties communicate with each other while viewing each other's situations through respective PC terminal monitors, that is, one in which the two parties can see each other.

Since computer software is expensive and various in the kinds thereof, the client PC terminal has installed thereon several popular applications, and the consultant PC on the consultant side is specialized in terms of business or consultation. Thus, it is necessary to perform business transactions while showing the task processing while an actual task is being conducted in the state where the specialized program is installed on the computer, and to get the other party's opinion, that is, the opinion of the client, while a conversation takes place therebetween, while smoothly and frequently making changes and modifications and observing the changes made by the other party.

Therefore, in order to realize a good business processing environment between the two parties, in the state where the server PC consultant accesses the client PC in a remotely controlled way and has remote control authority, if the server PC consultant accesses his PC terminal in a remotely controlled way by manipulating the client PC terminal, an oscillation phenomenon occurs in the remote control screen, as if a repetitive wave were formed on the two parties' PC monitor remote screens by repetitive transmission. Thus, there occurs a problem in which the contents of the other party's PC terminal monitor are unknown. To solve the problem, there arose the need for a bidirectional remote control business transaction processing system in which two parties can perform consultation while observing each other by providing one task processing PC terminal, in which a task program is installed, as the consultant's server PC.

In addition, as an important means for expressing one's opinion to a counterpart at a remote place, there is a method of transferring one's opinion to the counterpart by writing letters or drawing figures. It is difficult to accurately express one's opinion when the letters are written or the figures are drawn using the mouse of a PC terminal. Therefore, a liquid crystal tablet, a tablet notebook, a tablet, a pen mouse or the like, which has a function of enabling letters to be written or figures to be drawn, is used. In particular, it is necessary for an amateur to be able to perform the writing and drawing functions easily and smoothly by connecting the liquid crystal tablet to the PC terminal.

It was also required to output material or the results of work conducted on the server of a consultant to the printer of a client PC through PC remote control even when there is no person present at the client PC in a state where a camera for Internet image transmission is installed such that the materials or work results can be checked using the printer connected to the PC terminal on the client side and such that the PC remote control function is operated from a remote place over the Internet.

When it is necessary to transfer or print content between the client PC and the server PC, there are several methods, such as e-mail transmission. In particular, there is an additional folder movement function of moving material folders between the two parties through a PC remote control-based self-system in a PC remote control system. Further, as an alternative function, there is a function of remotely moving the output of a task, produced using PC software for a task, to the printer of the server PC terminal and then printing the output after a virtual printer driver program for remote control has been installed on a client PC (a PC for a worker) in a state in which the server PC is remotely connected to the client PC.

### DISCLOSURE

### Technical Problem

An object of the present invention is to provide an integrated business processing system, in which, in the case where PCs are installed at respective remote places and consultation is performed using the PCs through remote control when performing tasks, such as general paperwork and design work, for example, in performing consultation between a customer and a company, a tablet system for facilitating drawing and writing functions, a conference call, in which three or more persons can talk with each other at the same time, an Internet video conference system and so on, in order to perform consultation through third-party remote control between a main consultant PC and a customer PC, and a worker PC and also to perform business more efficiently are integrally constructed, so that amateurs for tasks performed using various computer programs can use the integrated business processing system easily and conveniently, and a consultant PC is connected to a client PC for bidirectional remote access control.

The present invention is an improvement on the technologies of Korean Unexamined Patent Publication Nos. 2006-0017668 (entitled “Franchise system using PC remote control business processing system and method”) and 2006-0017561 (entitled “Business processing system using PC remote control”), and Korean Patent Application Nos. 2006-0026479 (entitled “Business processing system using bidirectional remote PC control system and method”) and 2006-0033466 (entitled “Business processing system using bidirectional remote PC control system”), all of which were previously submitted by the present applicant.

The present invention relates to a company business processing global system and method using bidirectional PC remote control, and to an Internet portal site utilizing the same. In order to perform tasks, such as business transactions or design and office business, in a state in which a client side and a task processing side are connected to the Internet from different remote places at the same time via a wired/wireless or man-made satellite connection, one PC is installed on the client side, and two PCs or one PC and multiple monitors are installed on the task processing side, and they are connected to a PC remote control system. In this state, one PC, connected to the task processing side, that is, a company side, or one of two monitors controls the task consultation progress, and the remaining one performs business transactions while conducting a task. At the same time, the client PC displays the task processing and a modified task in real time through a bidirectional PC remote control system, and also immediately transmits completed work to the client PC so that it can be printed through the client printer.

In order to perform a proxy execution system using the PC remote control of a bidirectional PC remote control task system in great volume, it is performed locally in small cities and is also established nationally for businesses in a single cultural region. In order to smoothly carry out the proxy execution system using the bidirectional PC remote control basis for mass processing, it is necessary to inexpensively produce a business-assistant task processing in a batch way. Thus, there is a need for a business processing global system and method using PC remote control, in which an office room, in which business support staff work, is located in an area within the same country or in a developing country having decreased personnel expenses, and an auxiliary basic task is solved in terms of the task in association with the same kind of business.

The global system based on the PC remote control business processing system is a system that is widely used by the general public, including interior design companies, construction companies, various material companies, production companies, various sales promotion material, printing material or production factories, independent enterprises, students, numerous types of self-employed persons and manufacturers, customers using the same and so on. Due to this, since the system is a system having lots of content included in various types of shopping malls, it can become a total business franchise system if it is developed so as to have one step, and a portal site over the Internet can be easily constructed. Further, a global business franchise processing system based on the PC remote control system, which is simple to operate and manage, can be provided.

### Technical Solution

The present invention provides a system that is convenient and very efficient, in which, when three or more parties of a main consultant PC and an orderer or a customer PC and a worker PC perform business transactions at the same time in the case where a customer client PC and a company PC access a PC remote control system base, and perform business transactions progress mutually, the drawing and writing functions of the main consultant PC are remotely controlled through the PC terminal of a worker processing the business transaction via the ordering-site PC, so that business processing can be performed while performing consultation through PC remote control, a small-sized self-employed person can request an expert software company to solve problems since there is no expert capable of handling various programs in a small single-room office, numerous specialized workers in various fields reside on the franchise head office side, that is, the business agency side, and solve the problem, a small-sized self-employed person can quickly complete work at low cost, and a lot of tasks can be easily conducted in various fields without worrying about employee management.

If the PC remote control business processing system of the present invention is utilized, business transactions can be performed using the PCs of numerous experts, which perform tasks using various specialized software, and desired tasks can be performed through remote control at any remote place on any client PC. The PC remote control-based integrated business processing system of the present invention allows a SOHO personal entity or smaller franchises of various companies to remotely perform a variety of tasks even without expensive computer software for the task using corresponding task materials that are being worked on or have been completed in the task office room of a holding company, a head office or the like.

The integrated business processing system using the PC remote control system base of the present invention is a method of recording and keeping, as evidence, a task material consulting process while showing images that are being developed on a worker PC in actual colors, performing business transactions while writing letters and drawing figures in both directions, and transferring the content bidirectionally via remote access. In the integrated business processing system, business processing is performed in such a manner that after remotely being accessed by an orderer and performing business processing, a task processing company side has remote control authority, and therefore the task company side can delete all unnecessary content passed over to the order PC side, and then disconnect and finish remote connection. Thus, the task company side can perform trading under favorable conditions until a task cost is transferred.

### ADVANTAGEOUS EFFECTS

As described above, according to the present invention, if the PC remote control-based integrated business processing system and method, in which business, such as a design business, a construction business, a logistics business, a product development business, education progress and a customer service business, can be smoothly performed between two parties or multiple parties using an Internet web server-based PC remote control business processing system, a company business processing system can be produced to perform business, or personal business necessary for various business processes, a company operating system and a franchise service can be provided to any kind of company, such as various construction companies, education companies, design companies, fabrication companies, and global companies, or can be directly operated.

### DESCRIPTION OF DRAWINGS

FIG. 1 is a diagram showing the construction of a bidirectional PC remote control system according to a first embodiment of the present invention;

FIG. 2 is a diagram showing the construction of a bidirectional PC remote control system according to a second embodiment of the present invention;

FIGS. 3 and 4 are diagrams showing the construction of a bidirectional PC remote control system according to a third embodiment of the present invention;

FIGS. 4 and 5 are diagrams showing the construction of a bidirectional PC remote control system according to a fourth embodiment of the present invention;

FIG. 7 is a flowchart illustrating a PC remote control-based integrated business processing system of the present invention;

FIG. 8 is a flowchart illustrating a PC remote control-based integrated business processing system of the present invention;

FIGS. 9 and 10 are views in which a daily report for a worker, a web table screen and items, that is, part of a web database-based computational processing program operation, or part of the bidirectional PC remote control system of the present invention, are arranged;

FIG. 11 is a diagram showing the construction of a bidirectional PC remote control system according to a fifth embodiment of the present invention;

FIG. 12 is a flowchart illustrating the operational process of the bidirectional PC remote control system according to the embodiments of FIGS. 1 to 4 and 8;

FIG. 13 is a diagram showing the construction of a bidirectional PC remote control system according to a sixth embodiment of the present invention;

FIG. 14 is a diagram showing the construction of a bidirectional PC remote control system according to a seventh embodiment of the present invention;

FIG. 15 is a diagram showing the construction of a bidirectional PC remote control system according to an eighth embodiment of the present invention;

FIGS. 16 and 17 show the constructions of a bidirectional PC remote control system according to a ninth embodiment of the present invention;

FIG. 18 is a flowchart illustrating the operational process of a PC remote-controlled business processing system of the present invention;

FIG. 19 is a flowchart illustrating the operational process of the PC remote control-based integrated business processing system of the present invention;

FIG. 20 is a flowchart illustrating the operational process of the PC remote control-based integrated business processing system of the present invention;

FIG. 21 is a diagram showing the construction of an individual agent homepage in the bidirectional PC remote control system of the present invention;

FIG. 22 is a diagram showing the construction of an agent-based individual homepage in the bidirectional PC remote control system of the present invention;

FIG. 23 shows the web table construction of content necessary for a design task, that is, partial content of the bidirectional PC remote control system of the present invention;

FIG. 24 is a diagram showing a construction that is partially modified from the integrated business processing system using the unidirectional PC remote control basis according to the present invention;

FIG. 25 is a diagram showing a first construction illustrating the PC remote control-based integrated business processing system of the present invention;

FIG. 26 is a diagram showing a second construction illustrating the PC remote control-based integrated business processing system of the present invention;

FIG. 27 is a diagram showing a third construction illustrating the PC remote control-based integrated business processing system of the present invention;

FIG. 28 is a diagram showing a fourth construction illustrating the PC remote control-based integrated business processing system of the present invention;

FIG. 29 is a diagram showing a first construction which is partially modified from a company business processing system on the basis of the PC remote-controlled business processing system according to the present invention;

FIG. 30 is a diagram showing a second construction, which is partially modified from a company business processing system on the basis of the PC remote-controlled business processing system according to the present invention;

FIG. 31 is a diagram showing a first construction, which is partially modified from the company business processing system on the basis of the PC remote-controlled business processing system according to the present invention;

FIG. 32 is a diagram showing a second construction, which is partially modified from the company business processing system on the basis of the PC remote-controlled business processing system according to the present invention;

FIG. 33 is a diagram showing a third construction, which is partially modified from the company business processing system on the basis of the PC remote-controlled business processing system according to the present invention;

FIG. 34 is a diagram showing a fourth construction, which is partially modified from the company business processing system on the basis of the PC remote-controlled business processing system according to the present invention; and

FIG. 35 is a diagram showing a network group configuration in which small-sized chain stores and companies, which run a business on the basis of the logistics of new products, materials, etc., design business of retail sales stores, interior and exterior design companies, construction companies and various production factories of respective areas, proxy execution of offices and the like, are integrated in the present invention.

### BEST MODE

The present invention provides An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port; wherein the consultant PC first opens a consultant access administrator window of the PC remote control system, displays the consultant access administrator window on the monitor, and informs the client PC of a remote access request using a general telephone, so that the client PC is prompted to make access through a client adaptor or an access program through a website; and wherein a client makes Internet remote control access by clicking on a client access menu of the Internet remote control system base at the client PC, and then the consultant PC remotely accesses the client PC and causes the client PC to remotely access the consultant PC by manipulating the PC main body of the client PC under remote control authority.

### MODE FOR INVENTION

The present invention relates to an integrated business processing system, in which a conventional Internet web server-based unidirectional remote control system is improved to be a bidirectional PC remote control system in a one-to-one PC access state, a variety of functions, such as a tablet function for supporting the writing of letters and the drawing of figures, is added thereto, and various business processes are smoothly performed through the association of a client PC system, a consultant PC system, a franchise head office system, an assistant business PC system in terms of a business task, a construction site business processing PC system, an custom-built and material development PC system, a company head office warehouse and factory PC system, and a developing country production factory and export/import management PC system, based on a unidirectional or bidirectional PC remote control business processing system.

When the present invention is employed, a business processing system of various companies using PC remote control for unidirectional or bidirectional business processing based on the Internet can be provided, in which enterprisers who operate and start enterprises, such as interior design companies, various design companies, personal education institutes, signboard companies and global multinational companies, or a company's working-level task forces can perform a variety of business processes and corporate management procedures more conveniently and successfully.

A global Internet remote access business processing group of the present invention is a global group business system in which an integrated network group and business work relationships of all types of integrated business processes, such as an orderer and designer, a construction company, a material sourcing company and a construction team handling materials, labor, design, sale, management, etc. can be handled. The global Internet remote access business processing group of the present invention is a franchise group business system in which logistic distributors and retail sales stores of new products, materials, etc., interior design companies, landscape design companies and construction companies, and small-sized chain stores and companies that run a business on the basis of design conducted in various production offices in respective region and remote execution from distant offices are integrated and operated.

Constructions and operations thereof according to a number of embodiments of the present invention will be described in detail with reference to the accompanying drawings.

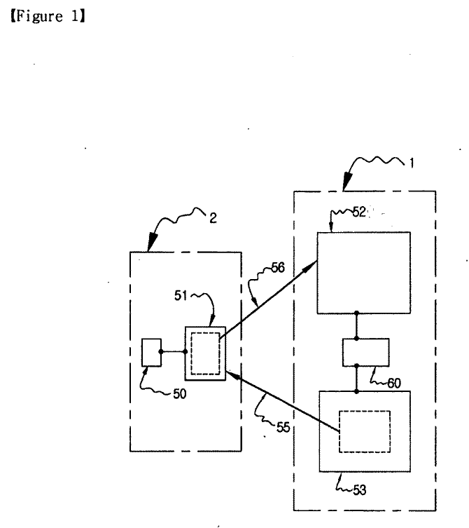

FIGS. 1 to 3 and 4 are diagrams showing the construction of bidirectional PC remote control systems according to first to third embodiments of the present invention. In the construction and system operation process of each bidirectional PC remote control system, a consultant PC 1 or 3 and a client PC 2 are connected via a communication means for the wired/wireless or satellite Internet in order to construct an Internet-accessible PC remote control system for a remote control method for various business processes between remote places.

In this case, the consultant PC 1 is a task manager PC, a server PC or a main consultant PC, as needed, the client PC 2 is a customer PC or a client PC, and reference numeral 3 designates a worker PC. For remote control, a remote control client module, a remote FTP client module, a remote chat client module, etc. are constructed. Furthermore, a corresponding protocol is analyzed and each thread is distributed and transmitted through a TCP/IP communication port.

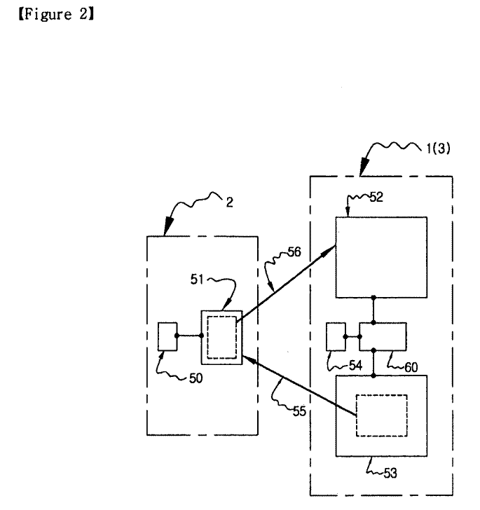

The client PC 2 of an Internet PC remote control system includes a PC main body 50 and a general monitor 51 connected to the PC main body 50. The consultant PC 1 or 3 of the Internet PC remote control system includes a PC main body 60, and multiple monitors 52 or 53 comprising a main monitor and an auxiliary monitor, including a liquid crystal tablet or a general tablet 54 (refer to FIG. 2) that has two or more writing and drawing functions and is connected to the PC main body 60.

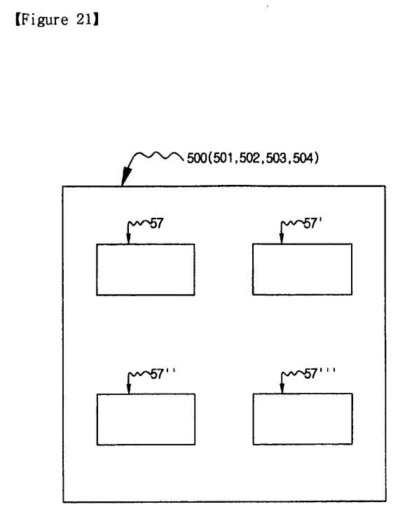

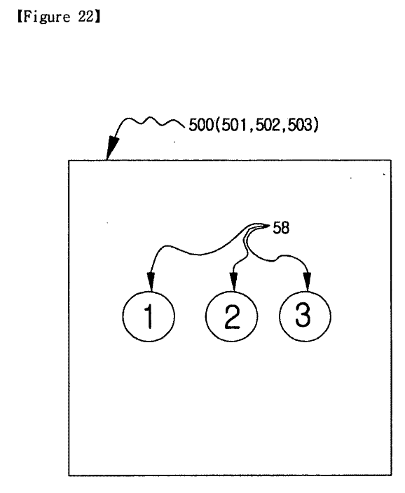

The consultant PC 1 or 3 first opens a consultant access administrator window of the PC remote control system, and displays it on the monitor 52 or 53 (refer to FIG. 1), and informs the client PC 2 of a remote access request through a general telephone in order to induce access through a client adaptor or an access program (57, 58) (refer to FIGS. 21 and 22) via a website. For Internet PC remote access, client adaptor buttons are arranged on an Internet homepage. One of the adaptor buttons, which are classified on a region basis or a consultant basis, is selected, and an individual classification symbol, name, contact telephone number, etc. of a client are input for access. Using the adaptor buttons, access can be easily gained by clicking once on a corresponding button.

Therefore, in the client PC 2, a client accesses the monitor 51 through Internet remote control (55) by clicking on the Internet remote control system-based client access menus 57 and 58. The consultant PC 1 or 3 remotely accesses (55) the client PC 2, and remotely controls the consultant PC 1 or 3 by manipulating the PC main body 50 of the client PC 2 in order to remotely access the consultant PC 1 or 3 under remote control authority. At this time, another consultant access administrator window, provided on an Internet website managed by the company operating the consultant PC 1 or 3, is displayed on the monitor 51 of the client PC 2 via remote control. The consultant PC 1 or 3 then remotely accesses (56) the client PC 2 by accessing client adaptors on the PC monitor 52 or 53 using one click.

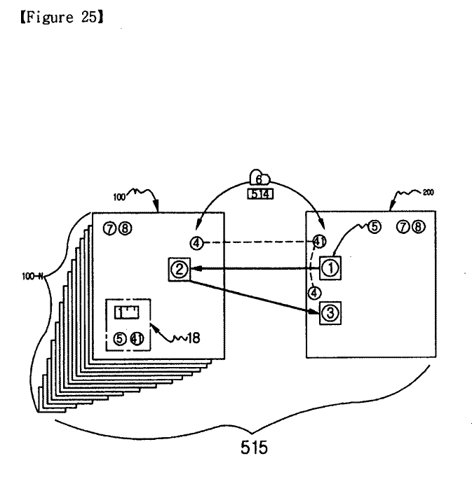

Thereafter, the screen does not oscillate and a normal bidirectional remote control system can be constructed only when the remote control access screen of the client PC 2 is moved to the auxiliary monitor 53, rather than the main monitor 52 of the consultant PC 1 or 3. Thus, a bidirectional PC remote control business processing system 515 (refer to FIG. 25) is constructed, in which any one of the main monitor 52 and the auxiliary monitor 53 of the consultant PC 1 or 3 is constructed as a liquid crystal tablet having the tablet 54 (refer to FIG. 2), or an additional tablet or pen mouse is connected to the PC main body 60 and a function of smoothly performing the bidirectional writing and drawing function is provided therewith, if appropriate.

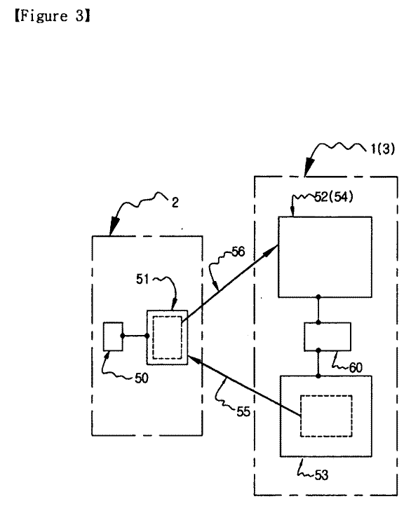

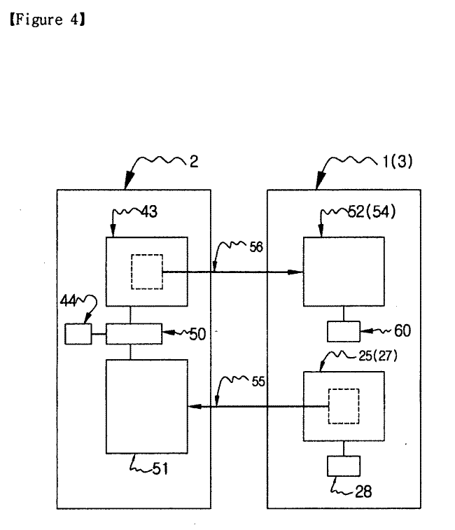

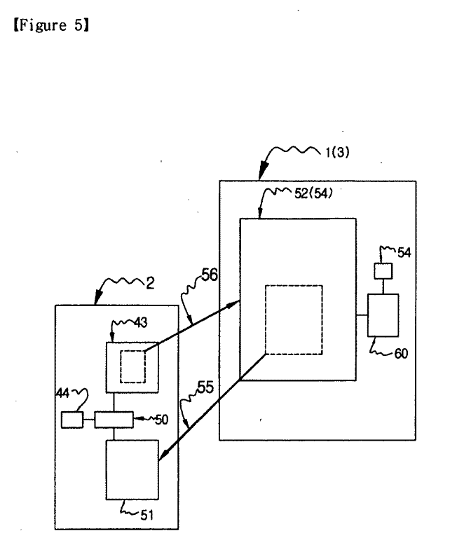

As illustrated in FIGS. 3 and 4, in another improved operation manipulation method of the operational methods of the bidirectional remote control system, when the client PC 2 performs the Internet remote control access (55) by clicking on the client adaptor menu 57 or 58, two-step Internet remote control access (56) can be performed more conveniently by setting remote control database coding in the client adaptor menu 57 or 58—an operation function of operational manipulation of another consultant access administrator window that is displayed on the monitor 51 of the client PC main body 50 by the consultant PC 1 or 3 through remote control manipulation—so that the operation function can be operated automatically in a complex and sequential way.

The consultant access administration window is displayed on the monitor 51 of the PC main body 50 through remote control manipulation after the consultant PC main body 60 remotely controls (55) the client PC main body 50 of the bidirectional remote control system configuration. The liquid crystal tablet and the tablet or the pen mouse or a tablet PC 44 for adding the writing and drawing functions to the monitor connected to the PC main body 50 is connected to the client PC 2 illustrated in FIG. 4.

The auxiliary monitor or the multiple monitors 43 is or are connected to the PC main body 50. A PC main body 28 that performs a task using a computer program is installed on the consultant PC 1 or 3. The main monitor 25 or the liquid crystal tablet monitor, the tablet, the pen mouse and the tablet PC 27 that performs a task using a computer program are installed at the PC main body 28.

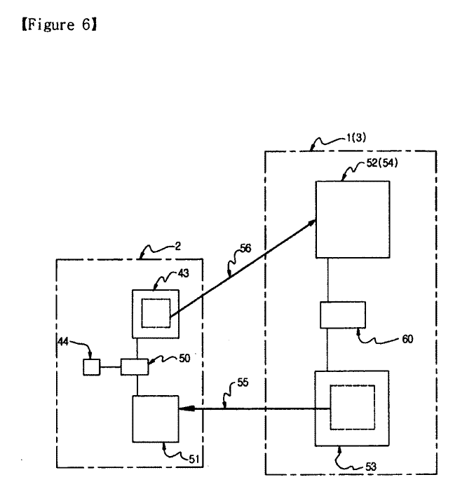

FIGS. 5 and 6 shows bidirectional PC remote control systems in which a client PC 2 includes an auxiliary monitor 43, a main monitor 51, a tablet function device 44, etc., in a PC main body 50, and a consultant worker PC 1 or 3 includes a monitor 52, a tablet function device 54 of a PC main body 60, so that after accessing the bidirectional remote control system, business processing can be performed without the screen flickering.

As the PC main body 50 of the client PC 2 is remotely connected (56) to the monitor 52 or the tablet function device 54 of the PC main body 60 in the consultant worker PC 1 or 3 through the auxiliary monitor 43 by way of the bidirectional remote control system, the monitor 52 or the tablet function device 54 is remotely connected (55) to the main monitor 51, resulting in the construction as illustrated in 5. As illustrated in FIG. 6, the PC main body 50 of the client PC 2, in which the tablet function device 44 is installed, is remotely connected (56) to the monitor 52 or the tablet function device 54 of the PC main body 60 in the consultant worker PC 1 or 3 through the auxiliary monitor 43 by way of the bidirectional remote control system. Thus, the auxiliary monitor 53 or the multiple monitors is or are remotely connected (55) to the main monitor 51.

When the bidirectional PC remote control system and method characterized by the construction and operational manipulation are applied in actual practice as a basic business processing system, it is possible to construct a bidirectional PC remote control-based integrated business processing system characterized by a variety of company business processes, such as various business organizational operations, company operations, network group operations, cooperation operating systems, franchise company operations and global group operations, a construction of an operational system, and a business operation, and a variety of company general business constructions and operational systems utilizing the same.

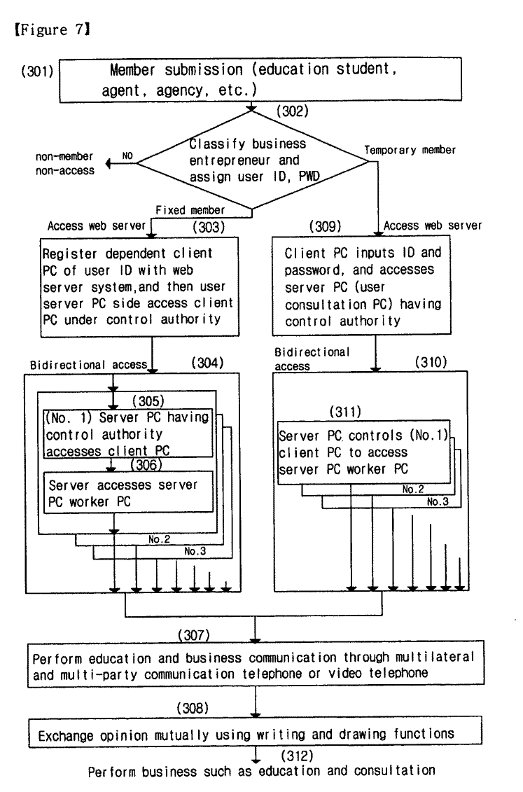

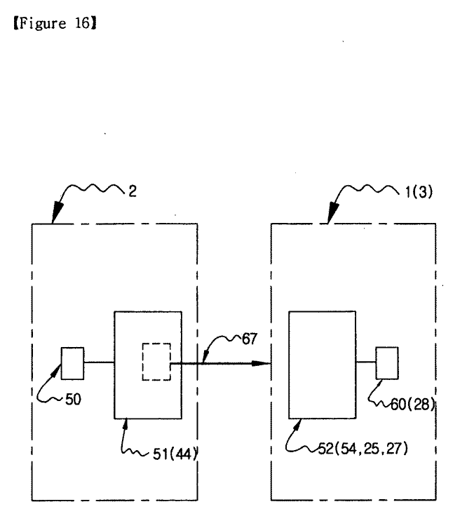

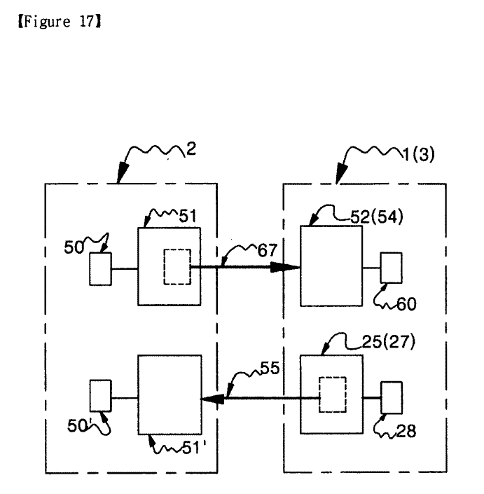

FIG. 7 is a flowchart illustrating a manufacturing process when the company business processing system using the PC remote control-based integrated business processing system and method illustrated in FIGS. 1 to 5, 6, 11, 13, 14 to 17, and 21 to 24 are operated in various companies, such as private and public educational institutes, interior and building construction companies, and so on.

For example, if a student, a chain store, an agent, etc. submits a membership request in order to utilize a service using the PC remote control-based integrated business processing system of the present invention in step 301, he or she is designated as a permanent member or a temporary member through business entrepreneur classification, and a user ID and password (PW) are assigned at step 302. The fixed member is registered with a web server remote control system as a dependent client PC of a user consultant ID. The consultant PC, that is, a user side, accesses the client PC with control authority in step 303.

The consultant PC having the control authority accesses the client PC unilaterally in step 305. The consultant server PC, having the control authority, controls the client PC to cause it to access the consultant PC or a PC for a worker in step 306. Thereafter, in a bidirectional access state (304) step, an educational and business call is performed through a conference call or a videoconference in step 307. Opinions are exchanged between the two parties through the writing and drawing function in step 308, and business, such as education and consultation, is performed at step 312.

The temporary member first accesses the consultant administration window in the consultant PC, accesses the consultant PC through the client adaptor by one click in the client PC, or inputs an ID and PW with the consultant administration window displayed on the monitor. A user consultant PC (a side having the control authority), that is, the consultant PC, accesses the temporary member. In a bidirectional access state (310) step, the consultant server PC having the control authority controls the client PC to have it access the consultant server PC or a PC for a worker. Steps subsequent to the call progress (307) step are the same as those of the fixed member.

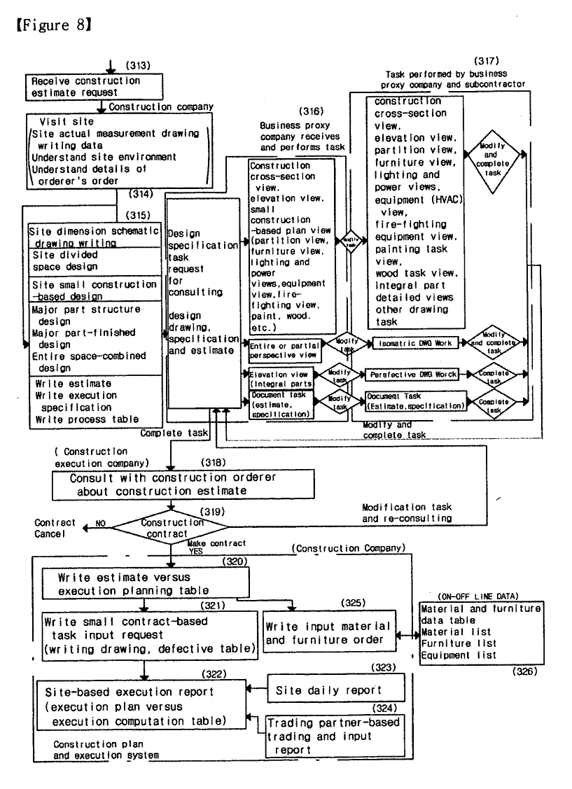

FIG. 8 shows a process of performing subsequent processes after a construction company submits a construction estimate request in step 313. The process is related to a process in which construction companies, such as an interior design company, a construction company and various construction companies, perform design and construction business utilizing the company business processing system (316) step using the PC remote control-based integrated business processing system and method illustrated in FIGS. 1 to 5, 6, 11 and 13. In particular, FIG. 8 is a flowchart illustrating a business process, such as a construction estimate request, a proposal and contract, and the onsite progress of an independent small-sized interior design enterprise.

When a construction company submits a construction estimate request, the construction company performs a site survey (a site survey drawing writing material, and investigation of the site environment and order content) in step 314, writes a site analysis (including a schematic site dimension drawing, a subdivided space design, a small site construction design, an integral part structure and closing design, an overall spatial associated design, an estimate, a specification, and a process schedule) in step 315, and submits them to a task agent company in order to request that a task be performed in step 316. If the task agent company requests a design drawing task for consultation (a design drawing, a specification, an estimate), a proxy execution task or a subcontractor modifies and completes the tasks, such as a construction plan view, an elevation drawing, a small construction-based plan view, a perspective view, a rendered view and a document task in 317.

The construction company performs construction estimate consultation for the construction client based on the modified and completed design drawing for consultation in step 318, and makes a construction contract in step 319. At the time of task modification and re-consultation, the construction company submits a re-modified task to the task agent company. When entering into a contract, the construction company writes an estimate and execution schedule table in step 320, and writes an input material and furniture order in step 325 with reference to a material and furniture material table (material, furniture and equipment lists) in step 326.

A site-based execution report is written in step 322 through a small construction-based task input request (a drawing for a task, a material-quantity table and an input process schedule) in step 321. The execution report also includes a site daily report in step 323 and a business partner-based trading and input report in step 324. A site construction and execution plan is managed using a database for accounting and business management.

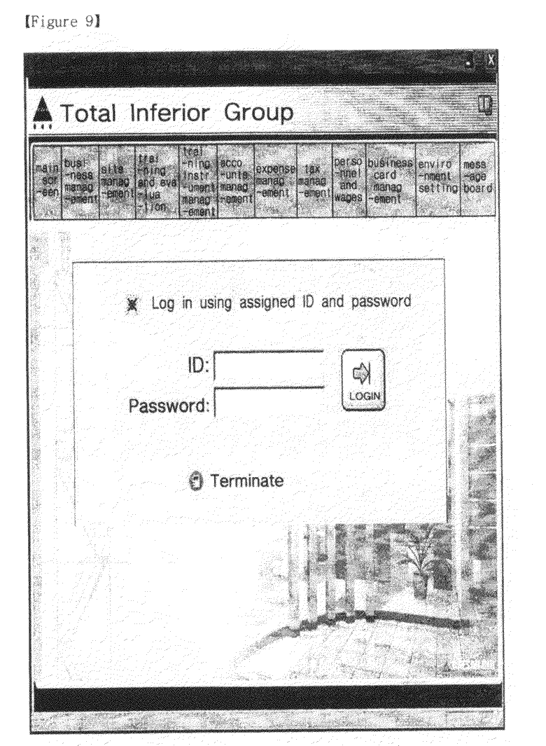

FIG. 9 is a view illustrating that a program is executed by inputting an ID and password into a main screen of a construction management web CS database program and a password input screen.

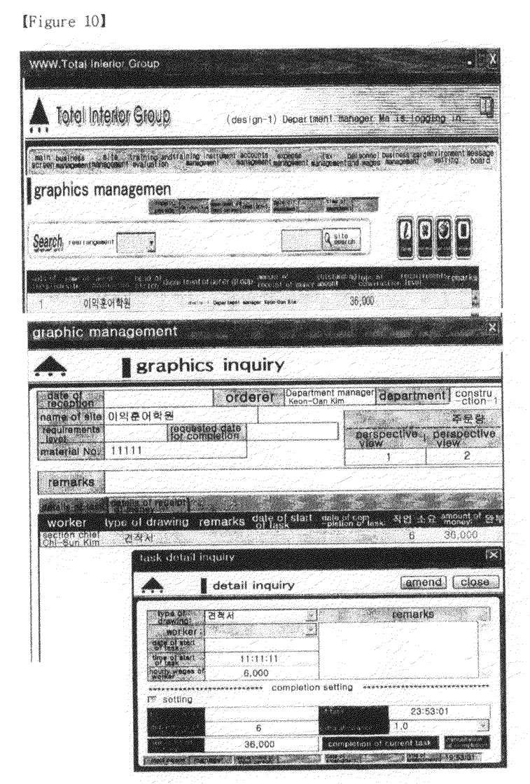

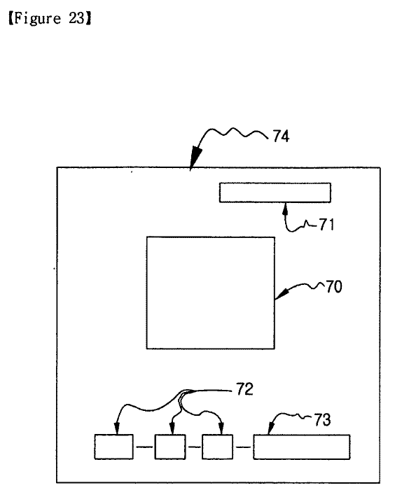

FIG. 10 shows a task report input window on a web table 74 (refer to FIG. 23) when executing a web database program for analyzing the unit cost of the worker PC 1 or 3 in terms of the operation of the remote control business processing system of the present invention using a web server.

An Internet database computational processing business process for material arrangement and unit cost analysis depending on worker-based classification coding, and an organizational management and global company organizational management system on a field basis, utilizing the same, are constructed as follows.

In view of a company part and a personal part, when classifying the company part and the personal part in terms of productivity in a private business or a corporate organization, the company part includes the educational environment, machine device investment environment, duty environment, intangible environment and so on. As for the personal part, it is influenced by the company part, but is operated based on the analysis of the productivity based on personal experiences and productivity. Basic material for evaluating a corporate organization can be obtained only when the activity and results of workers are analyzed. In order to operate a field-based organizational management and global company organization management system using the Internet database computational business process and method 24 hours a day, 365 days a year, and make the business processing smooth, there is a need for the PC remote control system of the present invention.

In the analysis and evaluation method on an individual worker basis, the grade is organized for respective types of work, and a daily task report is written. Major items are calculated on the basis of unit cost on a daily basis or a corresponding task basis (work time×hourly payment=task cost on a case basis). A task manager evaluates quality, etc. with respect to a corresponding case. Therefore, (case quality evaluation grade×Case work time)+case work time=case evaluation efficiency points. A totaled statistical analysis table is written on a monthly, quarter and yearly basis, and can be used to analyze business.

For example, the evaluation analysis table calculation equation for a monthly worker is as follows.

\textcircled{a} The number of days per month×work time per case (daily)×person-based task hourly payment×evaluation efficiency score per case=monthly evaluation task cost, \textcircled{b} the number of days per month×work time per case (daily)×person-based task hourly payment=executed task cost on a month basis, \textcircled{c} the number of days per month×daily work time×hourly task payment (work day÷the number of days per month×direct cost % or less=daily expected task cost (adequate monthly payment), \textcircled{d} the worker monthly payment that is actually paid.

Business and organizational management data is generated, in which worker-based evaluation analysis data \textcircled{a}÷\textcircled{d}=salary versus personal record, \textcircled{b}÷\textcircled{d}=execution versus personal record, \textcircled{c}÷\textcircled{d}=expected personal record, \textcircled{a}÷\textcircled{c}, and \textcircled{b}÷\textcircled{c} based on the resultant values of \textcircled{a}, \textcircled{b}, \textcircled{c} and \textcircled{d}.

Prime cost analysis with respect to an ordered task case and worker unit cost analysis of a task company are possible based on the worker evaluation analysis table. Workers who are distributed and perform tasks on the basis of a region or country can be easily managed, facilitating a global task operation and company operation. In various fields, business is often performed rapidly. In order to avoid problems in which various companies perform tasks only during the daytime and a worker who performs tasks at night must be paid additional fees, and task efficiently the next day is low, to solve the problem related to extra work, the global business processing system of the present invention can be used. Workers on the opposite side of the earth work during normal working hours, and thus night work can be avoided. Thus, there is an advantage in that the global company task processing system using the PC remote control system and method, in which all of an orderer, a company proprietor, and a worker can be satisfied, and the task can be performed 24 hours a day, 365 days a year.

In order to write a construction management program by applying the evaluation analysis table calculation method for a worker to a construction site management program, a classification code number system is required. For example, in the classification code number system for construction management, a project-based A.00 site, a construction type-base A-01 partition construction, A-02 woodwork, A-03 framework construction, factory-based A0101 1 floor A0102 2 floor A0103 3 floor, and history-based A0101 A personal expenses A0101 B materials A0101 C equipment A0101 D and so on may be used.

In order to operate a construction of 00 site of a large classification symbol called A-, in order to manage direct construction expenses, indirect construction expenses, general management fees, etc., small classification numbers between every classification process of a construction process basis are managed with respective connection numbers, and historical items are classified with lower serial numbers.

In the case of a corporate management computation system for trading related to an ordered task fabrication system for construction site management or an independent self-supporting system, an estimate and execution plan, and items of an execution history are aggregated to uniformly unite the flow of data. Therefore, estimate items versus execution history can be analyzed on a task-progress-step basis. An execution plan and execution history analysis, that is, a subsequent stage, can be generated. After the execution is completed, it can be used as business analysis data through completion analysis.

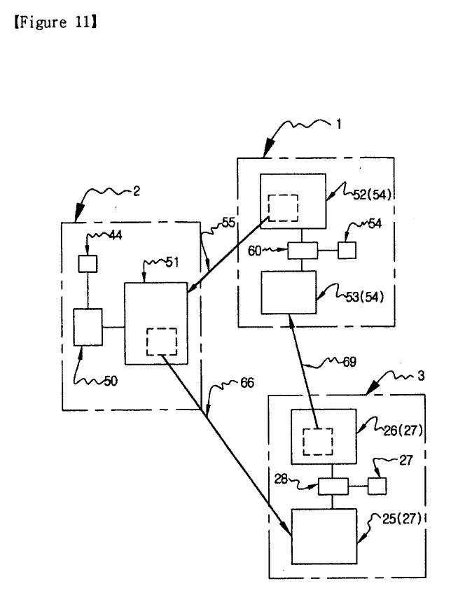

FIG. 11 is a partially modified embodiment of the basis construction of FIGS. 1 to 3 and 4. It shows an embodiment in which the bidirectional remote control-based integrated business processing system is constructed when a computer software worker PC 3 is in a remote place.

A main monitor 52 connected to a PC main body 60 is remotely connected (55) to a main monitor 51 connected to a PC main body 50 of a client PC 2. The main monitor 51 connected to the PC main body 50 is remotely connected (66) to a main monitor 25 connected to a PC main body 28 of the worker PC 3 that performs a task using the computer program. The consultant PC 1 accesses the client PC 2, and the consultant PC 1 remotely controls the client PC main body 50 and the main monitor 51 to remotely access the PC main body 28 of the worker PC 3 under remote control authority.

An auxiliary monitor 26, or multiple monitors, connected to the PC main body 28 of the worker PC 3 is remotely connected (66) to an auxiliary monitor 53 or multiple monitors of a PC main body 60. The auxiliary monitor 26, or the multiple monitors, remotely accesses the consultant PC 1 using a consultant administrator access window 68 and client access program buttons 57, 58.

The access window 68 is an Internet web server-based PC remote control access system, and includes a web table on the Internet website in the consultant PC for PC remote connection to the counterpart PC through remote access while the counterpart PC is observed under remote control authority.

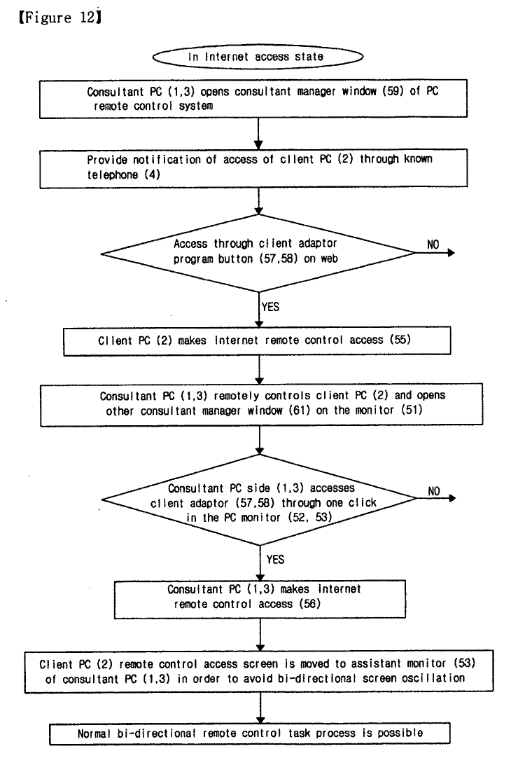

FIG. 12 is an embodiment of a flowchart illustrating a process of operating the system with respect to the content and construction of FIGS. 1 to 5, 6, 11, 13 to 16 and 17, and 21 and 22.

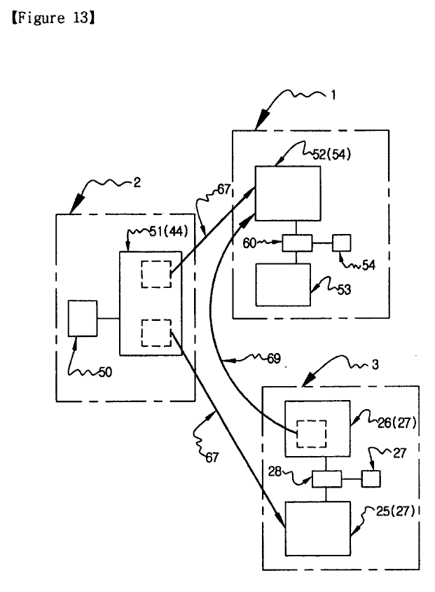

FIG. 13 is a modified embodiment of the bidirectional remote control-based integrated business processing system when the worker PC 3 is located in a remote place, as in the embodiment shown in FIG. 11.

In the client PC 2, the remote access consultant administrator access window 68, provided on a website, is first displayed on the main monitor 51 connected to the PC main body 50. A password is input. The window is opened and waits. The consultant PC 1 or the worker PC 3 is remotely connected (67) through the client remote access buttons 57 and 58 or the client access program. Remote access (69) is performed over the Internet by means of the consultant administrator access window 68 and the client access program buttons 57 and 58 between the consultant PC 1 and the worker PC 3.

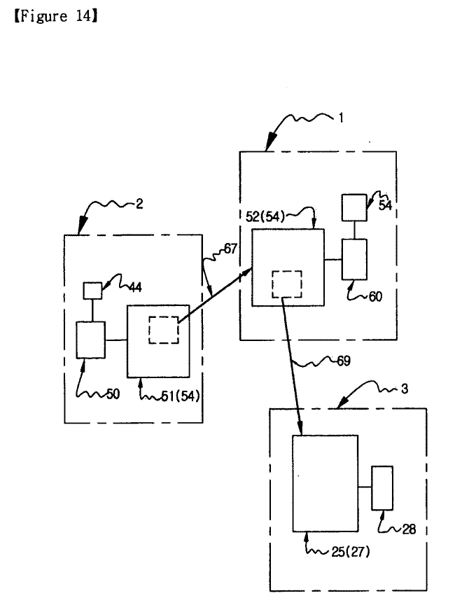

In FIGS. 14 and 16 and 17, when the consultant PC 1 and the worker PC 3 perform tasks while executing task software, there are lots of problems in the consultation progress since there is no expensive task software in the client PC 2. Thus, business processing cannot be performed. Thus, the client PC 2 first opens the remote access consultant access window 59, and the consultant PC 1 remotely accesses (57, 58) the remote access client.

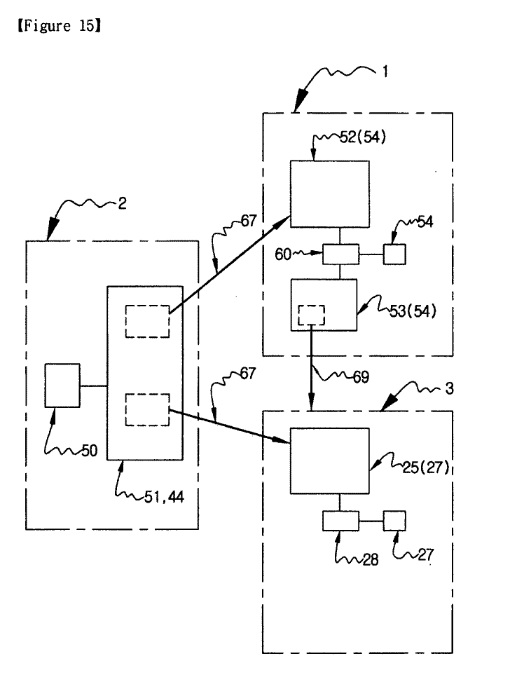

FIG. 15 is a modified embodiment of the bidirectional remote control-based integrated business processing system when the worker PC 3 is disposed in a remote place, as in the embodiment shown in FIG. 11.

The consultant PC 2 first displays the remote access consultant administrator access window 68, installed on a website on the main monitor 51 connected to the PC main body 50, inputs a password, opens the window and then waits. The client PC 1 or the worker PC 3 remotely accesses (67) the consultant PC 2 through the client access program or the client remote access buttons 57, 58. In a state where a third party is accessed, the consultant PC 2 shows a worker PC 3 screen that is being worked on to the client PC 1 using a screen send function, or is remotely connected (67) as means for showing the client PC 1 to the worker PC 3 screen, which is being worked on, in a reverse direction.

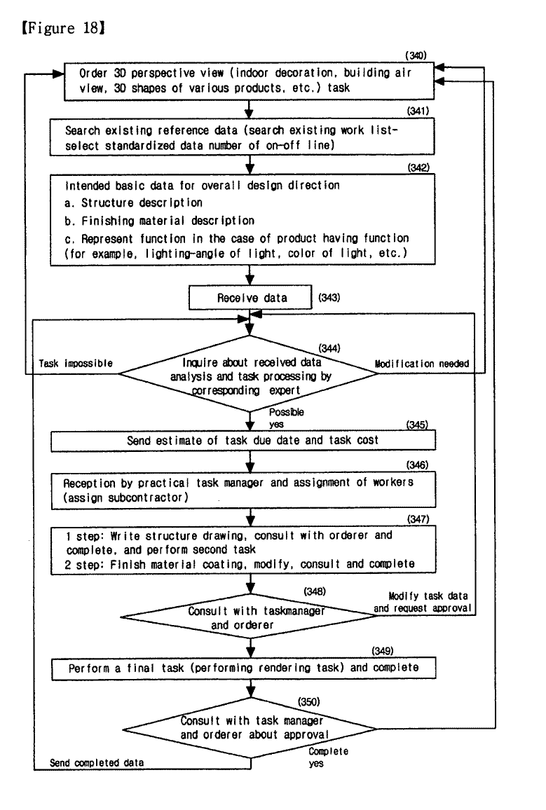

FIG. 18 is a flowchart illustrating a business processing process, such as the structure of an object, and the description of closing materials and functions in order for a worker who is working in a remote place to know the intention of a task orderer rapidly and confidently and to obviate unnecessary modifications, etc. when required work on a 3D-rendered view is performed in the construction industry, various design industries, manufacturing industries and so on.

When there is a 3D-rendered view task order (indoor decoration, an architectural rendering, 3D shapes of various objects, etc.) in step 340, existing reference data (existing work list search—selection of an on/offline standardized data number) is searched in step 341, a basic submission data item for a fabrication drawing to be performed (as basic data that is intended with respect to overall design direction, structure, closing material, and description of a function in the case of a product having a function) in step 342, and is then submitted in step 343.

An expert in a corresponding field analyzes the received data, and determines feasibility of the task in step 344. If modifications are needed or the task is impossible, the task is again ordered. If work is possible, the expert sends an estimate, including the estimated time and task fee, in step 345. The actual task manager receives the estimate and assigns a worker (or assigns a subcontractor) in step 346. The practical task manager consults with a task manager and an orderer in step 348 through a two-step process (first step: create a structural drawing; process a task using a sketch program and a structural work program, such as 3D-max; consult with an orderer and complete the task; a second step: a final material coating task, modification and completion) in step 347.

If data modification is required during consultation, modification and approval is requested from an expert in a corresponding field. If there are no modifications, the final completed task (rendering task) is performed and completed in step 349, and approval consultation with a task manager and an orderer is performed in step 350. If task modification is required during consultation, task modification and approval is requested. If there are no modifications, completed data is transmitted.

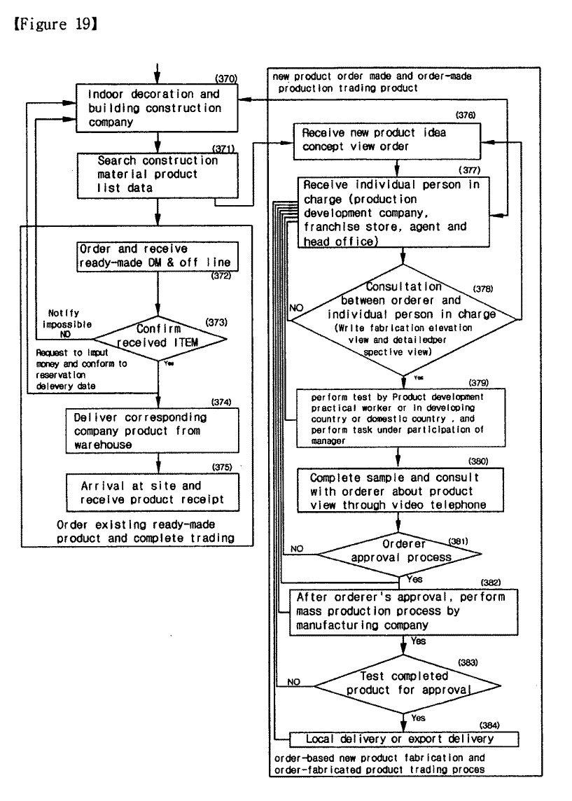

FIG. 19 is a flowchart illustrating a business processing process of a custom-built article in the case of, in particular, an interior design industry in the case where there is an order for construction material, an articles, etc. and business processing regarding a custom-built article in a construction business of various construction industries. FIG. 19 is a flowchart of an existing ready-made product or a new product order process.

An indoor decoration and construction company (in step 370) searches construction material product list data in the case of an order and trading of an existing ready-made product in step 371, orders, and submits a ready-made product on/off line in step 372. The item to be received is checked in step 373. If it is impossible, the impossibility is made known. If it is possible, delivery reservation notification and payment is requested. After the payment is confirmed, an article is output and delivered to a corresponding company in step 374. A site arrival and article take-over bill is received at step 375.

In the case of new product custom-built and order-based production trading, it is submitted to a development person in charge (a production development industry, a chain store, an agency, a head office) at step 377. There are a method of fabrication process approval request and mass-production order receipt, and a method of order and receipt (in step 376) of a new product idea concept after searching a construction material product list data in step 371. After the development person in charge receives it at step 377, an orderer and the development person in charge create a rendered fabrication view and a detailed view through consultation (in step 378).

If modifications are to be made, they are submitted again and consultation is performed again. If modifications are not to be made, fabrication is performed after a product has been inspected by a product development worker, and a developing country participates after a local manager has participated in step 379. When a sample has been completed, consultation with an orderer is performed through product photographing and videoconferencing in step 380, and the process returns to an orderer approval process in step 381. After the orderer's acceptance and approval, the manufacturing company mass-produces the product in step 382, approves and checks the completed goods in step 383, and performs inland delivery or export delivery in step 384.

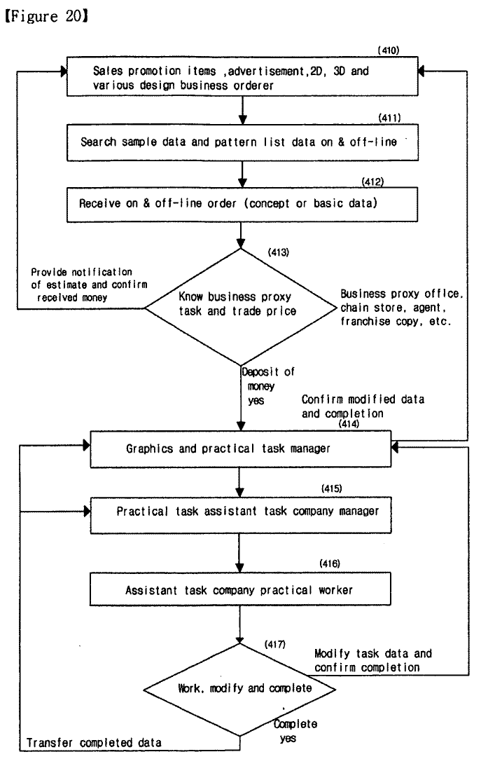

FIG. 20 is a flowchart illustrating the production process of various sales promotion materials, advertising editing, 2D or 3D design work, video editing and so on.

When various design work orderers, such as those ordering sales promotion materials, advertising, 2D, 3D and motion images (in step 410) search sample data and pattern list data in an on/off line way in step 411, and submits an order in step 412, a business is evaluated, the price is determined, an estimate is provided, and payment is confirmed at step 413. After the payment has been confirmed, a graphics and practical task manager (in step 414) performs, modifies and completes a task (in step 417) through a practical task assistant task company manager in charge (in step 415) and an assistant task company practical worker (in step 416). When data is ready, the data is transmitted to the practical task assistant task company manager in charge (in step 415) and to the graphics and practical task manager (in step 414). The graphics and practical task manager (in step 414) transmits the data to the orderer (in step 410) for data modification and completion confirmation.

FIG. 21 illustrates the state where access menu buttons 57, 57′, 57″ and 57′″ of a client adaptor program are provided on a website. In the drawing, reference numeral 500 designates an individual homepage on an agency basis, 501 indicates a website in which head office homepages are combined, 502 indicates an individual company homepage for architectural material and general article sales, and 503 indicates an Internet web server operated within respective regions of each country.

FIG. 22 illustrates the state where 1, 2 and 3 numeric button menu adaptors of the one-click access button 58 of a client adaptor program installed on a website are installed.

FIG. 23 is a view where various design data is classified and arranged according to serial symbols and numbers and is posted on an on-line Internet website, or common data, that is, a task method, etc., which is used off-line, is constructed according to the standardization.
□ Arrange basis data for plan views, such as architecture and various products.
Classify content symbols and abbreviations or objects for drawing notation, such as notation for wall material, doors, windows and tools, assign serial numbers, and fabricate a photographic image file, DWG extension for CAD and so on.
□ Arrange a closing material list and an object list for structural design computer program tasks.
Classify content, such as structural task set pieces and a closing material list for producing an object's structure, such as spatial designs or articles, assign serial numbers, and fabricate extensions of photographic image files and 3D design program objects such as 3D-MAX.
\textcircled{3} Arrange data for graphics, editing, web design, etc. according to each classification-based grade-based list.
Classify an overall photographic image or a partial image used to produce graphic design, catalog, web design, etc., and arrange them according to serial number. The same data are arranged and maintained so that they can be managed off-line.
\textcircled{4} Arrange lists of an interior rendered view, an exterior rendered view, an air view, a photographic image, an illustration image, etc.

When various data, such as \textcircled{1}, \textcircled{2}, \textcircled{3} and \textcircled{4}, are arranged and posted on the web table of an Internet website, all persons who are concerned with tasks, such as a corresponding worker, a consultant and a client, can see and use and them in the same manner. Thus, it is convenient regionally and temporally, and the serial number can be used uniformly while a web database computational process is monitored while transactions for various tasks are made.

In the drawing, reference numeral 70 designates various data, such as a photographic image, a graphical image, a motion image, a rendered view, a plan view, abbreviations and symbols, which are provided on a web page on an Internet-based website. Reference numeral 71 designates classified numbers arranged in order of serial number or classification number in order to classify and identify the various data 70. Reference numeral 72 indicates copyright-related classification numbers for expressing authors, managers, etc., who are related to the copyright of the various data 70, as abbreviations or symbols. Reference numeral 73 indicates notations, such as commercial prices, an image size and a printable size of data of the property right related to the copyright of the various data 70. Reference numeral 74 indicates an image storage web table on an Internet website in which the various data 70 are classified and systematically arranged.

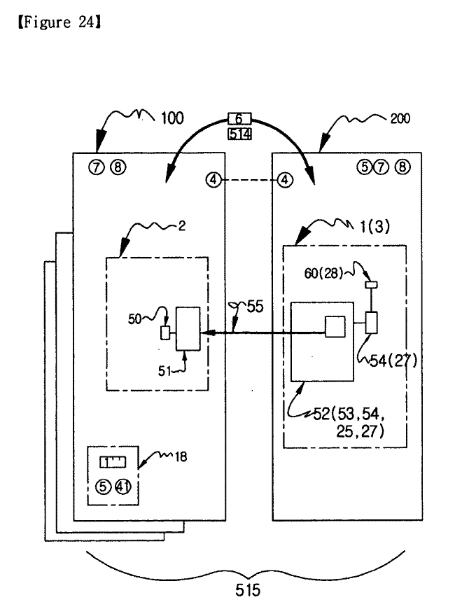

FIG. 24 shows a partially modified embodiment of a unidirectional PC remote control-based integrated business processing system of the present invention. FIG. 24 shows an additional writing and drawing function device 54 in which the consultant PC 1 or 3 opens the consultant administrator access window 68, and the client PC 2 remotely accesses (55) the consultant administrator access window 68 and performs business transactions and business processing in a unidirectional access control manner.

The client PC office 100 pertains to a customer, an agency, another involved business, a member, a chain store or an affiliated firm. The consultant PC office 200 is a main consultant PC or an upper-level person-in-charge PC from the aspect of business processing. Each office room is equipped with the telephone 4, the liquid crystal tablet 5, the printer 7, the scanner 8, a subcontractor who logs on to a client PC for consultation, additional portable equipment 18, and a telephone 41 and speakerphone for conference calls. Reference numeral 514 designates an Internet web server of a PC remote control system, and 515 is a remote control business processing system.

FIG. 25 is a diagram showing the construction of a system in which business processing is performed between two parties in various corporate organizations using the PC remote control-based integrated business processing system of the present invention in such a manner that a PC terminal is connected to a remote control web server 514 bidirectionally or unidirectionally in a remote control manner. A client PC office-N 100-N relates to a customer, an agency, another involved business, a member, a chain store or an affiliated firm.

The system includes a client PC office 100 having a client PC 2 of a PC remote control business processing system 515, a telephone 4 for making calls, a printer 7 for computer data output, a scanner 8 connected to a computer and so on, a consultant server PC office 200 having a web server consultant PC 1 for a major task manager of the PC remote control business processing system 515, a PC 3 for a computer worker of the main consultant, a liquid crystal tablet 5 connected to the PC 1 or 3 and configured to implement the writing and the drawing functions unidirectionally or bidirectionally, a conference call multilateral call function telephone 41, a general telephone 4, a printer 7 and a scanner 8 for a computer, and so on, and an Internet web server 6 used to store or exchange task data 21 for a computer and so forth.

When the client PC 2 opens homepages 500, 501, 502 and 503 on the Internet, inputs a user ID registered with a web server 514 for PC remote control, and subscribes to the unidirectional PC remote control of the web server 42, the web server consultant PC 1 for a main consultant remotely accesses the client PC 2. The server consultant PC 1 then controls the client PC 2 under remote control authority, and remotely accesses the PC 3 for a worker, who has previously registered with the remote control web server 514. The client PC office 100 and the consultant PC office 200 are bidirectionally connected, thereby constructing the PC remote-controlled business processing system 515 of the present invention.

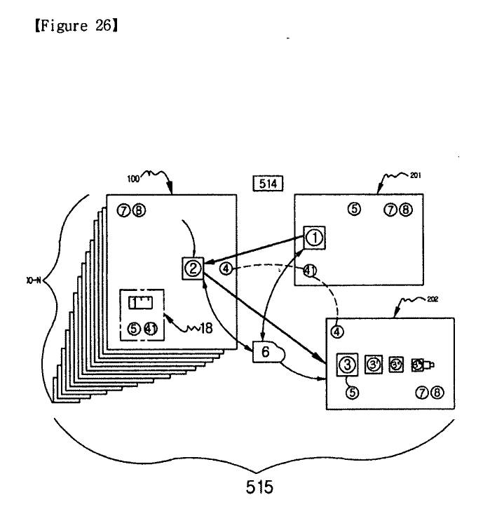

FIG. 26 is a partially modified embodiment of the PC remote-controlled business processing system 515 of the present invention, and shows the case where the PC 3 for the computer worker in the consultant server PC office 200 is constructed as an independent worker PC office 202 and various tasks are carried out at a remote place. The main consultant PC office 201 is a main consultant PC or an upper-level person-in-charge PC in terms of a business processing, and the worker PC office is a task administrator PC and a PC side that performs tasks using various programs.

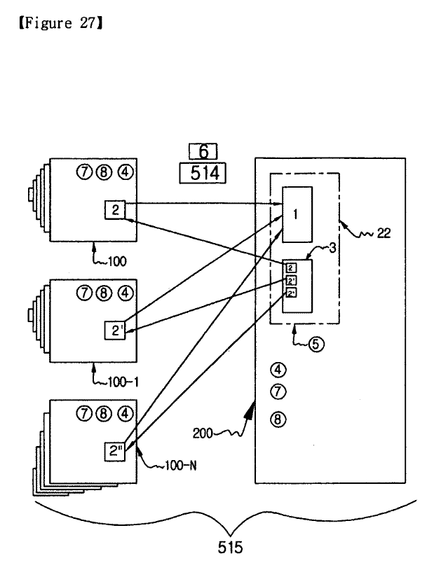

FIG. 27 is another partially modified embodiment of the PC remote-controlled business processing system 515 of the present invention, and shows the construction between a consultant server PC 1 and a worker PC 3 located within the web server consultant side office room 200 for a main business manager, and a plurality of client offices 100, 100-1, 100-2 and 100-N. Reference numeral 22 designates task data for a computer task.

An example in which the present invention is actually applied to a bidirectional PC remote control system for education will be described below. The client PCs 100, 100-1 and 100-N accesses the consultant PC 1, which a lecturer is using to give a lecture via remote control, and views motion image lecture content or other education data at the same time. The worker PC 3, located where the lecturer is located, remotely accesses the respective client PCs 100, 100-1 and 100-N, and the monitored states of the client PCs 100, 100-1 and 100-N are thus displayed on the monitor of the worker PC 3. Thus, at the time for individual questions and answers, a situation in which one-to-one partitioning occurs is created, enabling individual consultation and business processing.

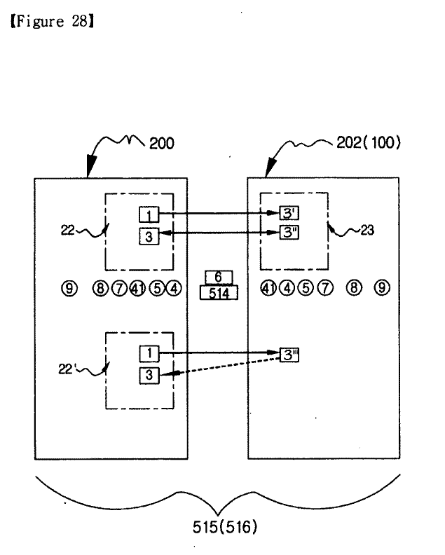

FIG. 28 is still another partially modified embodiment of the PC remote control business processing system 515 in the construction of the franchise system 516 using the PC remote control-based integrated business processing system of the present invention. It shows the construction of the bidirectional PC remote control business processing system 515, in which a main task manager PC 1 or 3 and a support worker PC (3′ or 3″) and the major task manager office room 200 or 202 are mutually connected. Reference numeral 23 designates an upper task and a task manager in terms of business processing.

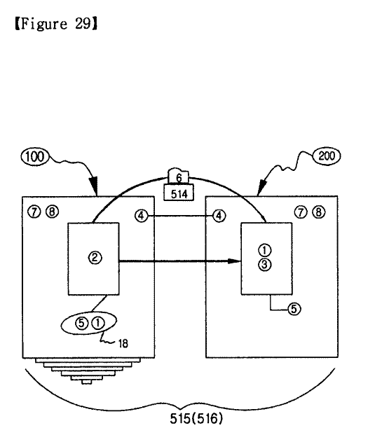

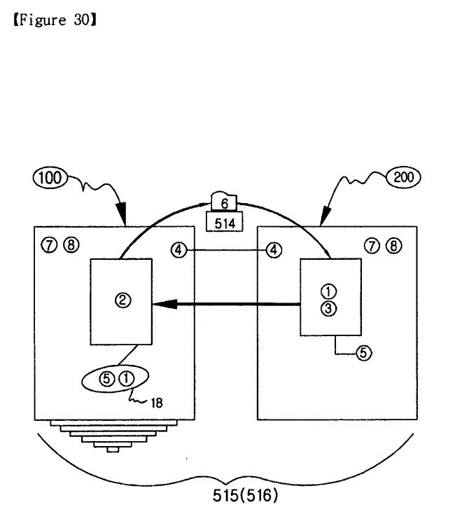

FIGS. 29 and 30 are still another partially modified embodiment of the PC remote control business processing system 515 in the contracting of the company business processing system 516 using the PC remote control-based integrated business processing system and method of the present invention. They show the constructions of the 1:1 unidirectional PC remote control business processing system between the client PC office room 100 and the consultant PC office 200.

FIGS. 29 and 30 show the construction in the case where a construction estimate and consultant 18, dispatched by the consultant office room or the company side 200, visits the client PC office 100 with a portable notebook PC terminal 1′, the liquid crystal tablet 5, and a multilateral call telephone 41 between three or more persons, if needed.

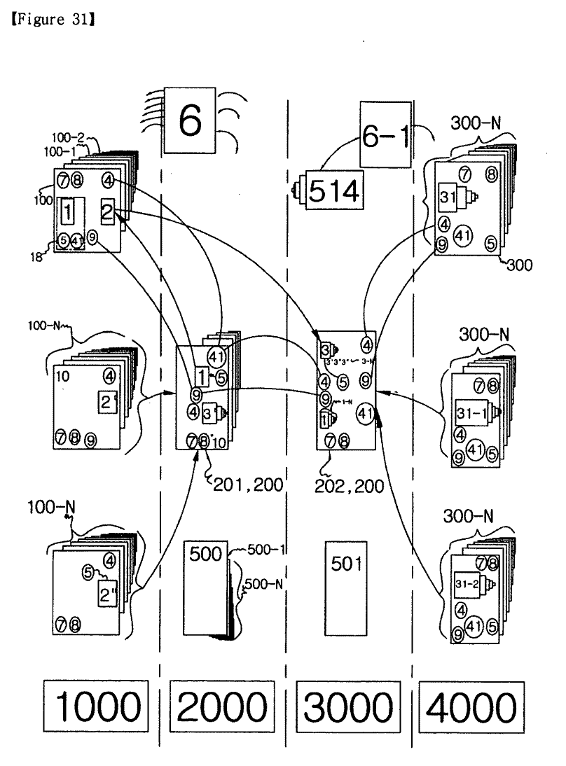

FIG. 31 is a diagram showing the construction of a system in which the company business processing system 516 using the PC remote control-based integrated business processing system and method of the present invention is implemented. The system includes a client PC system 1000, in which an affiliate, a common customer, a customer and so on, who employ the system service of the present invention, are arranged in a client PC office 100 and a plurality of office rooms 100-N, a consultant PC system 2000, in which a chain store, an agency, an affiliated firm, a SOHO chain store, and so forth, are constructed of a main consultant PC office 201, an agency-based web homepage 500, and a web hard drive 6 used for business, a head office system 3000, consisting of an upper task manager 22, a worker PC office 202, a head office homepage 501, that is, a combined total website, and a web hard drive 6-1, and a business auxiliary worker PC system 4000, including a lower-level task administrator 23, who helps conduct the business of the head office system 3000, and a business auxiliary worker office 300.

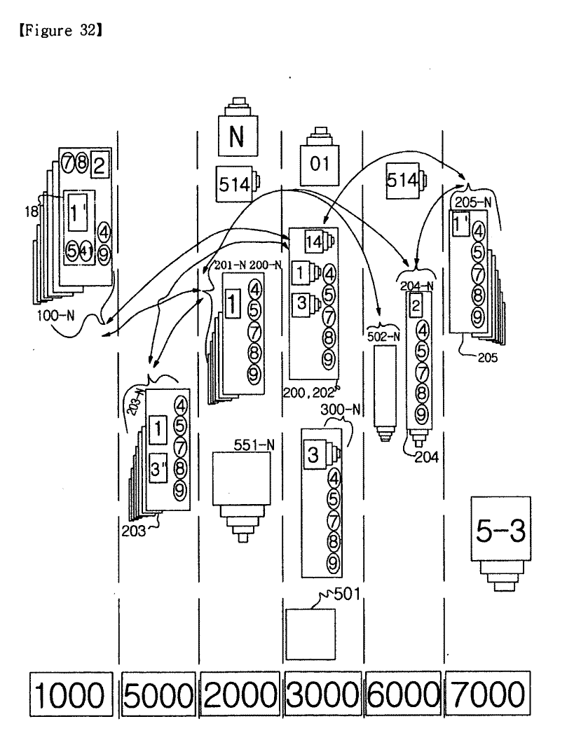

FIG. 32 is a partially modified embodiment of a system for implementing the company business processing system 516 using the PC remote control-based integrated business processing system and method of the present invention. The system constitutes a construction-site business processing PC system 5000, in which the client PC system 1000, the consultant server PC system 2000, the head office system 3000, and the construction site PC office 203 are additionally connected using the system 515 of the present invention in the construction industry in the case where integrated business processing service is performed.

A construction business involves companies related to business processes, such as the purchase, distribution and delivery of construction materials, articles, etc. The system includes a material and distribution system 6000 consisting of production companies and sales store PC offices 204 for material articles, etc., that utilize the PC remote control business processing system 515 of the present invention, and a custom-built and material development system 7000 consisting of custom-built or development company PC offices 205 that utilize the PC remote control business processing system 515 in a custom-order or development company concerned with materials, articles, etc., consumed at a construction site.

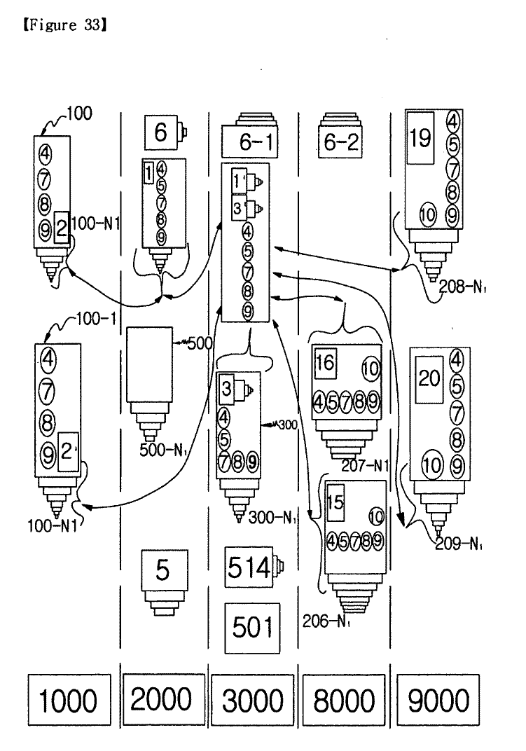

FIG. 33 shows a partially modified embodiment of the company business processing system 516 using the PC remote control-based integrated business processing system and method according to the present invention. FIG. 33 shows the integrated construction including the client PC system 1000, the consultant server PC system 2000, the head office system 3000, a company head office warehouse and factory system 8000, including manufacturing factory PC offices 206 and distribution warehouse PC offices 207 utilizing the PC remote-controlled business processing system 515, and a developing country production factory and the import person-in-charge system 9000, including production factory side PC offices 208 that utilize the PC remote control business processing system 515 in a foreign developing country, and import manager side PC offices 209 that import articles, in the case where a business processing of a corporate organization is performed using the system 515 of the present invention.

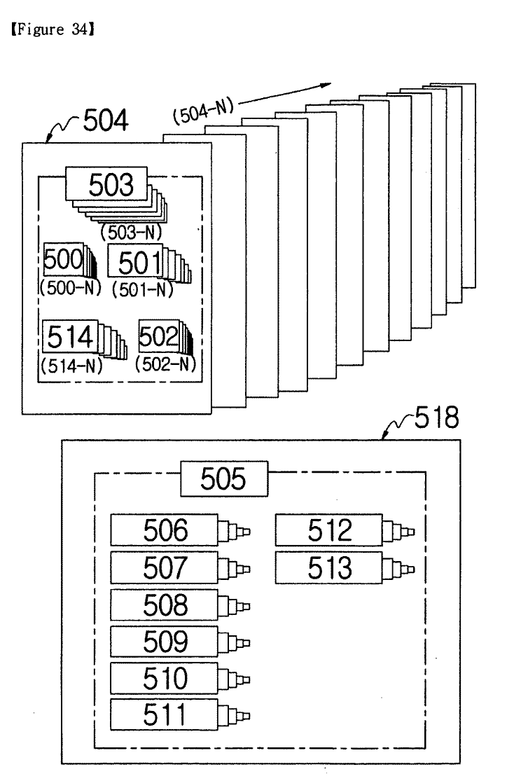

FIG. 34 is a diagram showing the construction of an Internet web server 503, an Internet web server 514 of a remote control system, a field-based head office homepage 501, etc. of a system operated within a single country, in the construction of the company business processing system 516 using the PC remote control-based integrated business processing system and method of the present invention, and shows the construction of global standard businesses 505, such as a web shopping mall construction and operation business 506, a symbol and data standardization business 507 of a material system, a symbol and data standardization business 508 of various design systems, a data standardization business 509 of various goods systems, a data standardization business 511 of various business management systems, a standardization business 512 for various commercial field-based planning systems, and other businesses 513, which are operated at a global group head office 518 that integrally supports the head offices 504 of an individual PC remote control-based integrated business processing system operating company.

FIGS. 7, 8, 18 to 20 are flowcharts illustrating a process of providing individual field-based business processing corresponding to the company business processing system using the PC remote control system and method of the present invention.

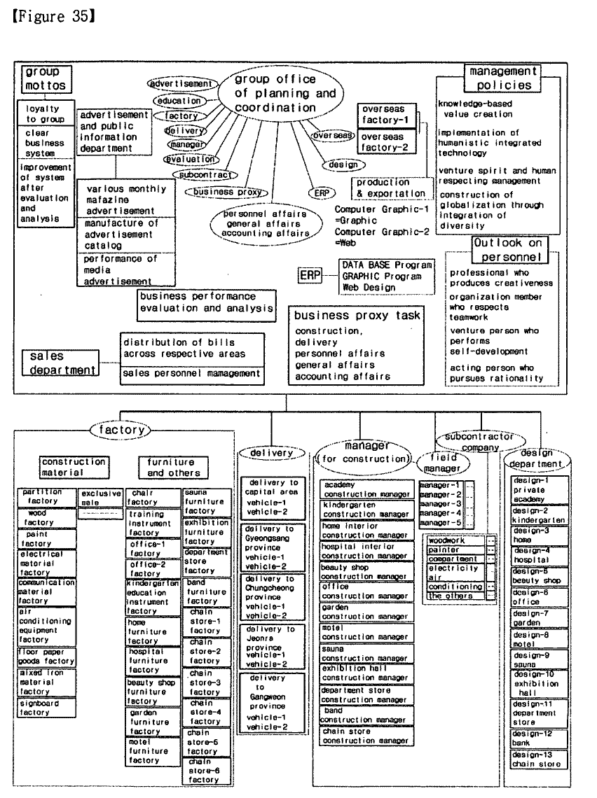

FIG. 35 is a schematic organization diagram of a network group in which small-sized chain stores and companies that do business based on logistics and retail sales stores of new products, materials, etc., interior design, landscape design companies, construction companies, design businesses for various regional production factories, the proxy performance of office work, and so forth.

The embodiments described above relate to the transmission/reception of data of various construction methods of the present invention. Of the Internet transmission/reception system construction methods for additional complementary business task data, data is transferred between two parties over the Internet using a centralized divided network-operated web hard drive or an independent web hard drive using a multi-user web hard system or web hard system such as that of WWW.WEBHARD.CO.KR, which is an Internet web hard drive dividing method utilizing an Internet web server and is operated by LG Dacom Corp., Korea.

The case where the present invention is applied to business transactions between a customer and a company, among the embodiments of the present invention, is described. In order to create an efficient relationship, including efficient management of business workers and monitoring of task processing, that is, in order to increase business management efficiency between a concerned business person and workers who perform tasks in remote places, after the client PC 2 accesses the consultant PC 1 or 3, the consultant PC 1 or 3 accesses worker PC terminals one by one, which are located in various remote places, by remotely controlling the client PC terminal, that is, a customer, and show Photoshop images, CAD files and MAX task materials, in which various programs are performed or being performed in real time, on the monitor of the client PC main body. Accordingly, consultation progress efficiency at the time of consultation, trust in a company, task quality and business efficiency can be maximized.

When there are two or more customers and a site consultation dispatcher who is dispatched by a company to the client PC 2, that is, the PC corresponding to the customer, when there are two or more consultants and the worker PC 1 or 3 at the consultant PC 1, or when there are also two or more persons on the worker side, people in the same place can observe content at the same time using a parallel-connected telephone or broadcast amplifier when it is necessary for all people to view communication content about the business processing in real time and to be aware of the same content. In the case of three or more remote control situations, persons at the remote places can communicate the business processing content. If it is necessary to know the content, a conference call telephone connected system of a third party multilateral communication method is used at an intermediate connection point.

Furthermore, when task materials performed at the consultant PC 1 or 3 using a computer program are printed and provided to the client PC 2, a remote printing function can be used at the time of remote connection, but is impossible to use for fine printing. Thus, a viewer program for a corresponding task program, which can be freely downloaded, is installed on the client PC 2 in order to print corresponding task materials.

Using the PC remote control-based integrated business processing system and method of the present invention, the business environment of companies in the construction industry, such as interior design, architectural, plant construction and finishing construction companies, can be advanced.

Worldwide, about 90% of interior design and construction companies are small-sized companies or self-employed persons. In construction fields such as interior design, architecture and finishing construction, one construction case is constructed as a self-supporting accounting file. Construction factors in the business of the business system of companies related to construction can be largely classified into sale, receipt, design, estimation, consultation, modification, contract, execution planning, execution, subcontracting construction progress monitoring, site management, material purchasing and management, equipment supplier relations, indirect site expenses, management of a head office and branch offices, and so on. It can be further divided into many detailed business items.

In order to efficiently operate a company having many business divisions, there is a need for an efficient specialized business organization in which productivity and originality can be increased with minimal investment, and continuous management of this organization is required. In order to realize this, a person in charge at one place can perform efficient management of customers or various businesses located in numerous remote places and can perform various transactions. In order to construct and operate such a system, there is a need for a PC remote control business processing system using the wired/wireless Internet.

In an interior design company operated by self-employed persons or small-sized construction companies, among several construction companies, the most important factor is sales and the second most important factor is contracting through consultation. The present invention plays an indispensable role in the process of performing sales and consultations and entering contracts, and is described below with reference to the drawings.

When a customer makes inquires about a construction project through one of several media, such as a telephone, or an Internet site, or when consulting with a customer after an introduction, a site dispatch expert is responsible for meeting the customer at a site, listening to site survey and customer requirements, reporting the requirements of the customer, site survey and site situation to a (company head office) construction consultation expert at a remote place through the PC remote control business processing system, and helps give an explanation between the customer and the construction consultation expert while performing the remote consultation progress between the two parties in conjunction with a site dispatch expert. The site dispatch consulting expert connects the PC remote control business processing system via the wired/wireless Internet to the consultant PC, that is, a main consultant, using a PC (notebook PC, etc.), a liquid crystal tablet, an Internet video telephone, a digital camera, a camcorder, a scanner and a multi-party telephone, and provides the construction consultation expert with consulting material regarding the construction site.

Data regarding a site is provided to the consultant PC on the part of the construction-consulting expert via the Internet using a PC terminal provided by the customer side. Alternatively, business transactions can be performed using a tablet. (A liquid crystal tablet or a tablet PC, which is hereinafter referred to as a tablet, refers to a tablet provided with a tablet board, a tablet painting pen, a tablet installation program driver CD, etc. in order to smoothly draw pictures.) Therefore, bi-directional business transactions between the customer and the construction company can be made efficient, the reliability of a construction company can be increased, and an environment of trust with respect to an important construction company, such as trust in subsequent contracts and construction progress, can be improved.

In particular, in the case of interior design companies, when a construction client is an organizational company or a head office of a franchise business system, they have their unique designs, such as brands, CIP or BI. In a construction design, a unique image of a corresponding orderer must be included in designs and constructions. In this case, a company image, etc. of a corresponding orderer must be included in components of small articles for a corresponding construction, the overall spatial design image or the like, for an attractive design. An overall spatial design must also be continuously modified in order to meet changing tastes over time and present a new design, partial parts and new small articles. Further, new design samples fitting the corporate image of an orderer must be produced through cooperation with a factory producing a corresponding product. The manufacturing unit cost must be determined, and information about new products must be presented to the construction client. When it is necessary for an orderer, a factory and a designer to conduct business while consulting with one another, a basic business processing can be performed smoothly with the trust of orderers and factories if the bi-directional PC remote control-based integrated business processing system, that is, the present invention, is employed.

Well-managed and advanced interior design companies or construction companies have their own factories that produce materials for construction or small articles for construction, or have a trading system for directly importing them from overseas or streamlining a distribution path. Those companies have been recognized as advanced and competitive companies since they make designs based on these advantages or factor the unit cost and competitiveness of the design into construction bidding.

In order to enable construction clients to recognize more construction companies as specialized and competitive companies and effectively turn the construction companies into advanced construction companies, the inventor of the present invention invented the bidirectional PC remote control-based integrated business processing system, which can be utilized by all construction companies. Each construction company can smoothly perform trades with an exclusive sales store, an agency or a sales store that handles materials for construction or articles for construction, or factories and import companies that import products from the foreign countries. Furthermore, in order to smoothly supply custom-built products and newly developed products to which desired designs are added, the following construction-related business processing business model is constructed in order to develop the corporate business processing system using the bidirectional PC remote control business processing system and method and supply it to construction companies.

1. Homepages, shopping malls or individual sites, in which tables in which lots of materials, articles, etc., such as construction materials, construction articles and small indoor decoration articles, are listed on an Internet website and displayed on an article or company basis comprise part of the system of the present invention.

2. The PC remote control business processing system of the present invention and an Internet video telephone are installed at local production factories, exclusive sales stores, agencies and retail stores of materials and articles related to the purchase of the articles, import companies that import them and so on, making them a part of the system of the present invention.

3. The PC remote control business processing system of the present invention and an Internet video telephone are installed in local factories within an industrial complex of various materials or articles, manager office rooms that perform the business of the import companies, and related overseas factories, making them a part of the system of the present invention.

4. Each construction company installs the PC remote control business processing system of the present invention and an Internet video telephone at its business office or a concerned construction site, making them a part of the system of the present invention.

5. Each construction company can order from individual local sales stores or production company import companies and make decisions through consultation when purchasing known standardized materials or articles or requesting the development of materials or articles for new designs. In particular, in the case of requested new products, whether an article fabrication factory is located locally or overseas, such fabrication can be completed only through confirmation and approval of a construction company that has placed an order on a fabrication-progress-step basis.

Therefore, business processing is performed such that both parties view design dimensions and shapes of an orderer through a 3D rendering using the PC remote control business processing system of the present invention at every confirmation step. When there is a disagreement between the two parties, consultation and modifications are performed while writing notes or drawing figures using the tablet. Regarding items of an article that is being fabricated, business processing is carried out while showing the actual object to an article fabrication side using the Internet video telephone. Furthermore, from the standpoint of a custom-built orderer, in the case of a custom-built development product for site assembly or site installation for a construction site, there are many cases where construction site situations, design intentions, etc. are known to the production company side.

In this case, the site situation is reported using the PC remote control business processing system of the present invention and the Internet video telephone installed at the site. At the same time, a fabrication situation at the fabrication factory can be known by a related construction management person and worker related to a corresponding construction site. In this state, related other tasks and the import of corresponding articles are performed. Thus, construction progress can be smoothly completed.

6. Business processing between the construction company and the article company is specialized and real-time progress is made using the integrated business processing system of the present invention. Thus, the construction client can also have a feeling of reliability as a specialized company, and the extent of trial and error can be reduced between a corresponding construction site and an article fabrication worker. Thus, a business model system with a rapid fabrication process and better quality management can be provided.

Thus, embodiments in which the company business processing system using the PC remote control-based integrated business processing system and method of the present invention is applied to various types of business fields are described below.

In order for interior or architectural construction companies to utilize the system of the present invention in construction sale consultation and estimation consulting, enter into a construction contract, and then describe detailed task content regarding items that must be traded and performed in the future by construction subcontractors or small article factories, understanding will be fast and construction business processing can be performed smoothly between two parties even though small-sized construction companies do not have the technical ability to handle computers if other site description data and task direction data are described while showing 3D data, rather than a simple method of placing an order using a plan view or elevation drawing.

Even at the time of corresponding construction site progress; in order for a site person in charge at a construction site to smoothly perform construction-site business processing through PC remote control when performing business transactions or construction business with respect to a corresponding construction project with the client PC 2, that is, a customer of materials and tasks using the PC remote control business processing system of the present invention, when it is necessary to show plan view or 3D data, a specialized worker can perform a drawing task using a 3D computer program and a construction business processing content method, such as Sketch-Up software, which was developed and commercialized in the U.S.A., and send a data file to the client PC 2, that is, a customer. Thus, since the Sketch-Up viewer program can be downloaded for free from the Internet, the 3D drawing, along with the data file, can be seen using the viewer program.

For example, an original ordering construction company can send a 3D drawing to a small construction subcontractor in order to describe a task, and make the small construction subcontractor aware of construction site content, so that materials and a construction progress can be completely prepared for a construction site.

As described above, when two parties have a conversation with each other about business at remote places, the two parties can have a conversation with each other while moving a 3D drawing up, down, forwards and backwards, and left and right, that is, while moving article or construction site program folder data in a 3D manner as if they were consulting with each other at the same place, or having a face-to-face conversation with each other. Furthermore, since description is given in detail by writing letters or drawing figures using the liquid crystal tablet, complicated content can be described in detail and can be simply understood by a counterpart. This is an indispensable business computer task for construction companies. Efficient utilization thereof by a construction business is made possible using only the PC remote control business processing system of the present invention.

When business processing between two parties is performed by receiving an order regarding task fabrication for an article or a 3-D object from a remote place, such as affiliated firms in which tasks are performed at remote places in the case of factories for custom-built objects, such as molding work or machining work, or even within the same company, 2D and 3D computer task programs, such as Sketch-up, 3D-MAX and Linor, are required. Renderings must be shown to a counterpart through remote control. Here, smooth business processing is made possible only when several detailed factors can be described using a drawing remote control function using the liquid crystal tablet. Thus, the business system must be necessarily provided in design and other business conducted by many manufacturing companies and fabrication companies.

When business transactions progress and business processing is conducted by a web design company, a web master and a database company for a business as well as many design companies, such as an architecture design company, various construction companies, an interior design company, an editing design company, a computer graphic design company, a video editing company, an animation company, an electrical design company, a firefighting design company, an engineering company and a signboard design company, which belong to respective types of business in each region of each country, the PC remote control business processing system of the present invention is required.

When a task that is performed or related at a remote place in one field is performed, basic sample data, such as standardized symbols, abbreviations and specimens, must be defined to form a standardized data system so that they can be known to all people and can be used together. In other words, Korea has KS (the Korea Standard). In all large-sized companies, company internal rules or self-standardization business rules or standards for business are databased in order to teach them to companies or persons. That is, task processes are unified. In advertising fields and CI and BI design fields, such as editing design industries, specimen sample data work is classified into numerous basic data and ID numbers and arranged in a web table of a website so that it can be utilized as basic data in trading and business processing in this field.

In order to enhance the efficiency and added value of business by integrating and globalizing types of business on a country basis by applying the PC remote-controlled business processing system of the present invention, worldwide data can be standardized. In order to realize it, a global franchise center company plays a central role in a data business, in which content-related items, such as symbols, abbreviations, articles and article symbols, are uploaded to an Internet homepage or a similar Internet website in an unorganized manner. It is therefore possible to use them individually or integrally on a field, company, agency, customer or country basis.

In order to rapidly publicize and transfer a large amount of data related to a business, a data room, in which large amounts of data are uploaded, and question and answer parts, handling detailed inquiries made to experts or concerned persons, are prepared. Pertinent and practical education content is collected, and practical data is constructed as an education data table. Independent table parts in which a customer individual, each agency and each company can secure independent regions are constructed. Sections, such as content, community, commerce and personality, which are integral components of a website, are created and added. Further, a menu or banner link region hyperlinked to an input window web table to which a server PC and a client PC of the PC remote control business processing system of the present invention is connected, and in which a user ID and password are input through remote control, is also provided.

If web sites based on businesses or fields are constructed, a data search engine web site of a total site can be constructed as an Internet portal site, such as Google or Naver.

In the case where the same kind of company and franchise head office is distributed in each country, the Internet operating speed within the same country as an Internet server and the Internet access speed of the same are fast, but the speed is different from the data transmission speed to other countries over the Internet. Therefore, the system must be operated on a country basis until an Internet-based environment using satellites is the standard.

When individually developing and managing a functioning system for the same kind and type of business on a country basis, there exists inefficiency related to personnel resources, reuse of task data, and loss. Thus, businesses of the same kind and type have a difference in quality and workflow as well as a difference in culture and business climate, but are the same with respect to fundamental business direction. Thus, there is a need for a company that can play a central role in terms of integration. Therefore, a global franchise group that continually performs development and efficient operation management is set up, and supports and integrally operates franchise head offices and individual companies in respective countries.

An example in which the construction system of the present invention is applied to various companies is described.

A. PC Terminal Remote Control Construction Business Processing System for Interior Design Company and Small Construction Company

Construction work, such as architecture and interior design, are based on drawings written by a design company and on a specification and an estimate written by a construction company, a contract is made between a construction client (a building owner) and a construction company on the basis of the design drawings and specification, and construction is performed and completed.

However, a commercial interior design or a small-sized construction company has an unprofessional system in which all items regarding construction, until consulting is performed based on design drawings, a specification and an estimate are written by a corresponding construction company, a contract is made, and the construction is performed and then completed, are handled by the president or staff of a small-sized company. Thus, the company can be maintained and developed only when the president or department head of the small-sized company can solve problems in various fields.

In order to achieve important projects, that is, outside projects, i.e., business sales related to many construction projects, and core items preceding a construction contract, that is, to have a good reputation as a specialist that can instill trust in a construction client (hereinafter referred to as an orderer), the business must be performed and progress must be demonstrated by an expert who is trusted in various fields.

In order to present a design to an orderer of a large number of designs, a specialized image is conveyed by combining several materials and small articles, including an interior design space, practical designs, management and science, finishing materials and the structure of construction components, a factory for producing them, a site management expert and a construction unit cost.

An interior design company does not produce materials, small article, furniture, etc. (or partially produces them) and is mainly understood to be a designer who combines data of construction components of spatial construction and unit cost information. Therefore, the interior design company knows many construction teams, that is, customers who construct each part, and performs construction consultation and progress between a construction client and a small construction interior design company. When a small construction company presents an interior design, the present invention supports a business utilizing the PC remote control business system so that an orderer can feel unique as a special interior design company and can be recognized as a specialized group or specialized company.

Experts in various design fields show large amounts of data and rapid design business processing to an orderer based on the progress and completed results of a corresponding construction project. Thus, trust can be created and confidence in subsequent construction projects can be increased. Furthermore, in order to provide trust in important construction progress and confidence in construction quality, items connected to sales store that produce or sell large amounts of materials and small articles can be designed by a designer of a corresponding construction company chosen by an orderer rather than a customer.

In order to change the perception of technicians or common people, who think that quality and unit cost are good when fabrication is performed by a manufacturing company, produce design items of a corresponding construction company by correctly recognizing and reflecting the intention of a designer, and make known the relationship with the factory to which a corresponding construction is applied, it is required that Internet shopping malls, which produce or handle large amounts of material and small articles and are operated by customers, and the custom-built progress relationship (which is difficult for a small-sized construction company to handle internally) in which new products are produced according to new designs conceived by the small construction company, be shown, and that mutual progress be made and checked.

In order for small-sized interior design companies to efficiently operate each business, there are needs for an organizational system for educating staff about business processing, calculations related to the construction business of each construction project, recruiting of operating expert staff, and specialized organizations in many parts, such as a head office management system of a corresponding company so as to increase the efficiency of productivity of respective organizational constituent members, that is, an integral part as internal factors. In organizational construction, management and development of numerous businesses, there is a need for a holding company of a specialized franchise system that thoroughly understands small-sized construction companies and can produce and manage related projects. Thus, if an affiliate or franchise is connected to the specialized holding company by means of a contract to form a specialized consortium in a given field, mutual development can be realized.

When it is necessary to solve a problem through consultation with a corresponding company or a franchise head office, by installing a PC terminal and an Internet video telephone at a construction site during a site construction progress, a specialized consortium can participate. Corresponding construction progress issues can be solved through consultation between construction clients, sites, companies and two parties using the PC remote control business processing system of the present invention.

B. Contract Articles with Chain Store Interior Design Company, Upper Company Head Office or Franchise Head Office

In an operating plan between a chain store or an agency and a franchise head office in the PC remote-controlled business processing franchise system for an interior design company, a contract relationship between two internal parties can be established depending on several trading relationships. For the purpose of trading progress that must be basically observed depending on each position, at least part of the following mutual agreement content is required for a mutual contract based on standard rules and advanced and continuing fulfillment.

A) When making a contact using an interior design company as the franchise system of the present invention, a construction company owner and an entrepreneur are some of the basic contract contents upon execution between two parties, with a construction company representative name being specified.

1. Fulfillment Content Basic Items for Construction Company

\textcircled{1} All responsibility in terms of civil and criminal cases regarding business transaction progress of each site, a contract, and corresponding construction and A/S of contracted construction.

\textcircled{2} All responsibilities in terms of civil and criminal cases regarding all items, such as planning and execution of a corresponding site, selection of a customer, and construction management and execution, are the basic responsibility of a corresponding construction company.

\textcircled{3} All relationships and progress with an orderer and employee management are the responsibility of a corresponding company.

\textcircled{4} It is an obligation that the PC remote-controlled business processing franchise system of the present invention be applied to office tasks of a corresponding company, site management in a construction site and so on.

\textcircled{5} Submission of construction settlement data to a franchise head office after construction (this does not correspond to management of a corresponding construction project at the head office, but is utilized as general reference data, so that it is necessary to submit data after completion of construction).

\textcircled{6} Expenses, which are determined internally according to an appropriate ratio, of a total construction cost of a corresponding contract construction, in view of corresponding company advertising expenses, franchise use expenses, various design task costs and so on, are paid to a franchise head office.

\textcircled{7} In Korea, the responsibility for construction lies in the contracted party, a bill collecting company and the company managing the construction. Thus, a franchise head office can visit a corresponding construction site or can allow the staff of a corresponding company to monitor and audit a site with respect to fields other than items, that is, the situation of materials invested in a corresponding construction project.

\textcircled{8} Data relating to sale, consultation, contracting, construction progress, the present condition of a customer, the present condition of a subcontractor, the present condition of employee management, etc. is submitted to a franchise head office.

\textcircled{9} All rights are limited to a franchise head office only, in order to prevent and protect the external leakage of site photos and data after various design tasks.

\textcircled{10} When there is trade between customers, such as site consultation, and site enforcement and management, which do not employ a franchise system, it is against the contract.

\textcircled{11} Published data and the right of the ownership by a personal company based on a place of personal business are owned by a head office. It is stipulated that all items are leased, used after leasing, and requested during a franchise contract period (a homepage, shopping mall, other data, a database and the like).

\textcircled{12} Telephone numbers and mobile phone numbers of a corresponding construction company, which are supplied by a head office, are owned by a general franchise head office, and no other party has the right of ownership thereof.

\textcircled{13} When a contract between two parties is annulled for any reason, subsequently, an entrepreneur cannot be registered in the name of the person himself or family members in the direct line of the person himself, including substantial activities of the person himself, for 3 years in the same kind and field of industry. The entrepreneur cannot be employed as personnel or staff in other companies in the same kind and field of industry. If this term is violated, the person himself cannot submit any objection even if a provisional disposition is instituted for a project and even if it is a construction that is performed using another person's name, other than the name of the person himself. This corresponds to behavior infringing the know-how of a franchise system, and is an item that is recognized by the person himself of a construction company operating person, that is, a chain store.

\textcircled{14} After contract content is sufficiently understood, a franchise contract is made between two parties. The contract is fulfilled in good faith. After the contract is executed, it will be sincerely fulfilled according to the contents. No objection will be raised against the disposal thereof, and no lawsuit will be filed for civil or criminal reasons.

\textcircled{15} A corresponding construction company will comply with the annulment of a contract based on any reason or decision of a franchise head office.

C. Company Business Processing Business Model Using PC Remote Control Business Processing System and Method for Specialized Construction Company

In the case of architectural construction or interior design, rather than small-sized construction, an orderer, that is, a building owner, requests a design office room to write design drawings and specifications by applying the architecture law and several related laws, selects and compares construction companies through several methods, and makes a contract of a construction. The contracted construction company frequently consults with a design supervising person and an agent designated by the orderer, that is, a site supervisor, about detailed construction items while performing the construction, and modifies the detailed construction items through an agreement with a site construction company. In this process, the site construction company must acquire approval from the site supervisor or the design supervising person, in addition to a legal approval procedure, and performs several construction business processing items that must be performed. The system in this procedure can be performed in different ways, but is a construction progress business system for accomplishing objects though smooth construction progress when viewed in light of the design intentions of a construction client and a designer and the position of a construction company.

Therefore, for good construction completion having good quality, first, a design company must have information about a specialized material company that sells good materials inexpensively, and must have specialized design creation ability and presentation ability using the same. When approximate architectural construction expenses are analyzed as a percentage, such as a design ratio is 7% or less, labor expenses 30% or less of direct construction ratio, material cost 30% or less—equipment cost 10% or less, indirect site cost 10% or less, construction company head office management expenses are 10% or less, and so forth, a competitive mutual relationship achieving a high quality and a low unit cost can be established, and mutual advancement can be accomplished only through selection of a material factory that supplies construction materials and efficient management of the operation of the material factory. Therefore, for smooth business cooperation, if the construction company and the material and article factory perform business cooperatively using the PC remote control business processing system, that is, part of the present invention, advancement can be made based on mutual reliability, outside reliability and efficiency.

Second, there are lots of good business processing types using a computation processing system, since the ratio of labor expenses is high in a construction progress. In order for small-sized teams or small-sized subcontracting companies to have a system that can be operated without experts, it is better to perform construction efficiently by mutually using the PC remote control business processing system, that is, part of the present invention, which is a more efficient and improved management method.

Third, design supervising business processing with a design supervising person is efficiently performed, business processing, such as site confirmation and item approval, with a site supervisor orderer is efficiently performed, and a site staff business processing, that is, indirect site costs, and business processing of site cost items are efficiently handled. In order to efficiently perform business processing, such as the investment and management of site equipment and task statistics, and to efficiently perform business approval, cooperation, and management in the relationship with the head office and branch offices of a construction company, business processing can be performed efficiently by mutually using the PC remote-controlled business processing system, that is, part of the present invention.

D. Business Processing System Using PC Remote Control Business Processing System and Method for Office Task Agent Company

Office proxy execution companies distributed in respective cities have a lease office room function of performing simple office business and leasing a desk for some amount of money per month. If the PC remote control business processing system and method, that is, part of the present invention, is employed, office proxy companies and personal freelance SOHO workers existing in each region can be integrated to form a diverse franchise group, so that a business supporting specialized subcontracting businesses can be performed.

A franchise head office has various fields of expert designers and experienced workers, such as specialized workers, a presentation worker, and CAD, MAX and rendering experts, so that business, including editing design-specialized tasks, computer graphics, design business, various document business, various presentation productions, editing design, and remote support company executions can be performed. Thus, group organization operations, such as high level tasks that cannot be solved in lower franchise chain stores and agency and assistant business, can be specialized to produce a large-sized group organization.

Internet websites have specialized homepages on a field basis. The Internet websites include various basic data and specialized design reference data, education data, queries and answers, a bulletin board, a member data page, a member work page, an evaluation page, a temporary job and job-hunting page, personal blogs, and so on. Through them, a business can be united by enabling a customer, a lower agency, a franchise head office, a business-assisting office room, etc. Constituting elements have unified and defined abbreviations or symbols, so that mutual communication is easy.

As a method of lowering the production unit cost by accomplishing a large amount of tasks inexpensively when many tasks must be accomplished by activating a franchise system using the PC remote-controlled business processing system and method of an office task agent company of the present invention, business-assisting companies can be set up in developing countries, or subcontracted office work can be inexpensively imported from the foreign countries in association with related companies.

In the present invention, a franchise head office or upper manager can monitor task situations of PC terminals of overseas (developing country) workers and all workers who work in franchise chain stores and agencies in a local lower organization through PC remote control, as if real-time task situations of lower workers were being executed on his PC terminal monitor. At the same time, description can be transferred to a counterpart worker at a remote place in detail through PC remote control while smoothly writing modified items or instruction items using a tablet. Further, communication is possible while observing the current situation of a counterpart office room through the Internet video telephone. All business management progress and personnel can be managed as if workers in remote places were seated in adjacent seats.

For reference, since Korea's language and alphabet are Korean and Hangeul, Chinese Koreans living in China can use both Korean and Hangeul. Thus, companies having a Chinese Korean as a manager and a Han race Chinese person as a task practical staff can be set up and operated over all the areas of China. Further, when the franchise system using the PC remote-controlled business processing system and method of the present invention is activated in the U.S.A. and an assistant business task processing company is required, a lower organization company can be set up and operated in English-speaking areas, such as the Philippines or India, in which English communication is possible. When associating a lower task to a subcontracting company in a developing country, a manager who can speak the language of local workers and interpret the language can be dispatched to a place having the franchise head office of the present invention.

E. Company Operation or Franchise System Using PC Remote-Controlled Business Processing System and Method in Signboard Field

Signboard stores in the advertising signboard field have small-sized signboard stores in individual villages, and are operated as personal businesses by self-employed owners. The signboard stores provide consultation about sales based on 2D elevation drawings when performing sales consultation. Therefore, in order to perform drawing tasks to operate 3D specialized computer programs, expensive and specialized computer software and specialists must be secured, but are difficult to secure by small-sized and trivial companies.

Frame fabrication, necessary in signboard fabrication, the installation of completed signboards, and so on, are subdivided, and are ordered and processed by signboard frame-specialized production companies and signboard installation construction teams. Thus, regional signboard stores perform only small sales, and conduct sales and business based on computer design programs, a PC, and cutting machines for tinting for signboards at self-office rooms.

In order to specialize trading environments with specialized workers for the sharing and editing of specialized design data and 3D business processing, signboard frame-specialized fabrication factories, and signboard specialist installation teams, increase efficiency, and increase competitiveness and added value for various types of businesses, a franchise system of a signboard-specialized company type, and further, a franchise system utilizing the PC remote control business processing system of the present invention is required.

When each regional signboard store photographs a place where a signboard will be installed using a digital camera and sends data of a desired design and expected cost of a customer to a head office, a franchise head office produces the signboard as a 3D drawing of a building elevation drawing. An editing designer and 3D workers produce data that the customer can see stereoscopically, and then send the data to the signboard store office room in the region, or can instantly modify the data and show modified data when the customer consults with a self-employed signboard store person.

Through such a business cooperation system, a self-employed signboard store person can have an increased specificity and thus improved sale efficiency.

A self-employed person can directly see the processing of a signboard ordered through a video telephone with a signboard frame fabrication factory, and can check the dimensions of the product ordered through PC remote control. Thus, the system is a business system having an efficient business processing and no error. Specialized homepages constructed based on the construction photos of many signboard designs, related laws, and various communications with customers are operated for independent enterprises and specialized franchise groups. The franchise head office also monitors customer trends while directly trading with special sale companies that can directly trade with large-sized customers.

F. Company Business Processing or Franchise System Using PC Remote-Controlled Business Processing System and Method for Office Furniture and Partition Company

As in a signboard field, in the case of a site built-in custom-built furniture design of office furniture, or in the case where furniture delivery site conditions and several order items are taken into consideration, there is a need for a component list website because the components of the furniture are manufactured overseas. Thus, there is a need for a system for the checking of a franchise head office staff residing in an overseas industry area or a manufacturing factory, and the business cooperation with a supply person in charge so that the furniture can be supplied rapidly in view of site conditions. After the components of the furniture are rapidly supplied, local fabrication parts may be assembled at a construction site or at a local fabrication factory. There are on- or off-line associated company integrated catalog fabrication and associated shopping mall operation.

G. PC Remote-Controlled Business Processing System for Crystal Trophy and Counterpart Company

This is similar to the above-described system. There is off-line associated company integrated catalog fabrication, but the management of associated shopping mall fabrication and operation is required.

H. Company Business Processing or Franchise System Using PC Remote Control Business Processing System and Method for Various Design Companies and Other Companies

There is a need for the construction of a company operation management system or an associated franchise field-based group system in various design companies, such as an architecture design company, an interior design company, electrical design and fire fighting design companies, a real estate agent office, a licensed tax accountant office, an attorney office, a patent attorney office, a judicial scrivener and so on. It is needed for in various fields in which the various businesses of companies are performed using PC business processing remote control over the Internet, such as PC remote control business processing between government and public offices operated by a country, various large-sized companies and small and medium-sized companies and site design departments of various construction sites, a PC remote control business processing between the design-related departments of large-sized company head offices, lower affiliated firms or respective branch offices, and agencies between manufacturing business head offices and subcontract companies, and the places where business or tasks are performed using computers, such as all businesses such as self-employed freelancers, SOHO workers, iron frame construction companies, stone construction companies, and graphics and video editing manufacturing companies for cinema fabrication.

I. Basic Concept and Purport of Construction of Integrated Network Global Group for Architecture Indoor and Exterior decoration construction companies, design company, and Office Proxy Company

Basic factors in architecture indoor and exterior decoration small-sized construction corporate organization operations are analyzed and classified as follows: A) indoor decoration design, exterior decoration design, B) construction—1. construction method development, productivity improvement through efficient operation of direct construction expenses and indirect expenses, such as labor expenses and material expenses in details of direct construction expenses, C) the efficient operation of sale, D) the efficient operation of general management in a head office and a branch office, E) financial support.

A large-sized company is integrally operated using a large amount of fund and the organizational operation of the abundant specialized manpower of various business organizations. It is thus possible to make sufficient profits by handling all fields extending from construction to sale in the complex development and execution of a large project. In contrast, small and medium-sized companies are incompletely operated due to the shortage of technology, fund, experience, management and operation capability, sale and so on, which are basic elements in management, due to the incomplete operation of short specialty manpower, the short capability of designs sense, the low price reception of orders due to bleeding competition with other companies, short fund, short technology and so on, and is then finally dishonored.

Of various elements, specialized construction operation based on good design and efficient productivity, the low-price supply of good materials, the operation of specialized construction team and so on are basic cores. Consequently, it is necessary to provide various building construction companies with the direct import of overseas materials, the supply of cheap unit cost materials, the supply of good design, active operation through the education of a specialized construction team, and a computational operation system. In order to efficiently perform project processing in conjunction with an architecture owner, that is, a construction client, a designer and a construction company so as to perform one architecture indoor and exterior decoration construction project:

First, a rendered view and an air view showing the colors of the finishing materials of a design drawing part composed of drawings, an estimate and specification are important. These are a design from a visual point of view. Experts in colorful design fields, such as visual design and art, perform tasks. It is effective to perform and process a business using the computer Internet remote access business processing system of the present invention.

Second, when the details of the performance of building construction, interior design, etc. are analyzed, material cost and labor expenses are the major parts of the direct construction expenses. In particular, the direct import of the materials of new products or the purchase of them from factories allow the materials having low price and good quality to be purchased. An orderer and a customer prefer good materials that are cheap and have a good quality, and want new products and new materials to be used from a design stage. An orderer prefers a specialized construction company which can completely execute a design determined in this manner.

A specialized construction company collectively refers to a worker or specialized construction team and a specialized construction company having specialized technology and functions in terms of the details of construction for which design is determined. In particular, a new site to which new products and new materials are applied requires a specialized construction team that is experienced or has special education.

When finding a company that is good at a construction, an orderer searches for a specialized design company, selects a specialized company that pursues a detailed and good design utilizing good materials in the design stage, and entrusts the construction to the company. The global Internet remote access business processing group of the present invention is an effective and developing global group business system in which an integrated reliable relationship can be constructed through the integrated business processing of all fields, such as an orderer, a designer, a construction company, a material supply company and construction team, including materials, labor, design, sale, management and operation.

If it is activated as a group in every field,

1. Coloring Air View and Rendered View Task Processing Network Group System of Architecture Design Company Offices

An architecture design is delivered to a customer after finishing a colorful air view, an internal rendered view and so on in the case of a large-sized construction. This is characterized in that, since a coloring computer task expert performs a task, a company having a large architecture design office organization can perform the task, or the task is required to a subcontractor company. A specialized task proxy company that activates the coloring computer task processing based on the Internet remote access business processing system of the present invention is a global business processing system that can manage the tasks of nationwide and worldwide architecture design offices and interior design companies economically and rapidly at a high quality in corresponding countries, and can efficiently operate the lower business workers of a developing country.

For example, in a small-sized architecture design, when a draft design is provided to an architecture owner without charge, a colorful air view is also provided without charge. Since main design is performed after a paid contract, in which case an internal stair-based perspective view, an outside air view and so on are provided to the architecture owner at low price in detail.

2. Global Network Group System that Integrates and Operates Small-Sized Chain Stores on the Basis of the Distribution of New Products or Materials, Retail Sales Stores and Construction Inside, Outside Design, the Design Business of various production factories in each region, and the Proxy Executions of Office Rooms

Non-experts find business items anywhere in the world. Due to this, there are many people who want to live by creating the income. If a business that can be easily operated and stably developed is provided to the general public, it constructs a global group that can be easily operated and spread worldwide. Management business and Internet business processing bases of various computer task design business processes and material distribution and sale using the Internet remote access business processing system of the present invention allows persons who do not know the computer task to perform a business system and a business process in real time, in which a small-sized office proxy office and a product sales store in each region can be integrally opened and managed, and to receive a unit cost analysis and specialized task processing system. Thus, it easily operates a chain store company, that is, a small-sized company in a personal region. Therefore, productivity can be improved through integrated group formation of a worldwide chain store company, and the task processing and management/operation in each country of specialized task execution companies in which a detailed business processing is divided, and consequently a specialized company can grow.

In order to fulfill good trading conditions, first, new products are shown fast, sold inexpensively and supplied rapidly to customers. Second, products and materials at a high level are cheap and supplied rapidly. Third, customers, that is, architecture and interior design companies, are supplied with specialty, education and activation of materials and ended construction companies so that high level design and construction can be performed. Fourth, the customers of architecture design offices and interior design and construction companies are supplied with completed computer task processing and the various design data of various estimates, CAD drawings, rendered views, air views, etc., or collected or specialized computer task processing and various design data. Fifth, the customers of various article fabrication companies are provided with the specially processed business of a computer graphics task, an article development assistant task, an office business assistant task and so on. Sixth, a group is operated in association with respective regional small-sized companies that have specialized equipment, such as a large-sized real output device, and provide customers with good quality outputs, equipment lease, etc. inexpensively.

3. Global network group system that distributes, Produces and Supplies Worldwide New Products and Materials to Worldwide Chain Stores and Office Proxy Execution Office Rooms.

In order to develop design fields, such as worldwide interior design, architecture design and various design fields and understand the market, it is necessary to process tasks rapidly and inexpensively by integrally connecting products of each country of a corresponding field and the design and construction markets, and to produce, distribute and utilize developed products. In particular, the interior design and architecture design fields are the integrated construction design of total items, so that there are needs for information, samples, etc., such as various materials and small articles. Further, subsequent construction companies must be supplied with the articles. Accordingly, since it is necessary to process a design stage and an execution stage at the same time, it is required to provide network group chain stores in each region of the world with the highest quality items, such as the latest materials, new products, the highest quality materials, architectural materials and furniture, or common products in a common purchase form or a direct supply form inexpensively and rapidly.

To this end, a network group must be operated such that resources, such as an order, purchase, test, forwarding and warehouse of competitive products, and the staff, are organized and operated, and the data of numerous resources can be moved integrally through communication means, such as the Internet, in real time. Consequently, a distribution warehouse and management staffs operated by the network group of the present invention must reside in a production company, an industry complex and a distribution center area in each country, so that products can be directly supplied to worldwide chain stores or must be supplied via an intermediate logistics system.

4. Network Group System, Such as Integrated Consultation of Field-Based Special Designer and Development Proceeding Portal Website Construction Operation

In the case of each country's interior design, design patterns of respective workers are different, the flows of designs are different for every type of business ordered by customers, and the preferred cycle of the interior design market is very short. A basic factor in the interior design is that interior design decorating the space and a construction can be performed only when materials and small articles constituting the space in each region are supplied. Thus, it is necessary to construct a common development or cooperation system through consultation with interior designers in some other area, who are engaged in the same kind of business.

A multilateral Internet remote access conference can be performed in real time through the development of a videoconference and multilateral conference system. Thus, the global network group system of the present invention can be subdivided into various design fields so that designer-related persons subdivided on a country, field and task basis can consult with each other, and product development and methods related to a determined design can be shared and supplied. In this case, related product production companies and development persons in charge commonly take part in and perform a task.

5. Integrated Operation Management ERP Operation System

The IT knowledge information industry can process a large amount of information data between workers and between users rapidly and accurately in real time, can give reliability to persons concerned, and can be operated worldwide on a large scale. This is because the investment value of invested fund into party companies can be increased by constructing good design capability and the cooperation system of construction companies and distribution-related companies. In order to activate the input and cooperation of fund investment companies, it is necessary to construct the computation of a transparent business system that can be reliable to related companies using the database, SI, the wired/wireless Internet, various solution technologies, etc. of IT field. A system utilizing a computational business-processing program over the Internet and the dedicated line is necessary.

An integrated website operation and management system having the group intelligence construction of a technology system, such as on-line public encyclopedias including Wikepedia, the knowledge search service of Naver, etc. in which lots of technology-related companies and technicians take part in groups, exchange opinions and perform tasks cooperatively, and the UCC construction in which individual users can directly produce motion images and can share them (such as motion images of www.youtube.com, personal blogs, etc., in which content directly produced by users can be shared over the Internet) is constructed.

6. Organization Management System of Global Network Group Head Office

In order to group and operate chain stores and pertinent companies of point organizations located in each region of each country, and various distribution-related companies, it is necessary to operate and manage respective departments necessary for the operation of a global network group head office, such as general affairs, accounting, personnel, labor, education, technology development, product development, construction method development, import and export business, factory management, overseas factory operation management, distribution, an education department, interior and architecture design department operation and management, web design, IT institute operation such as SI, operation and management of various chain stores on a field or country basis and franchise head office, sale activation on a group basis, the operation and management of portal website and ERP, the operation and management of an integrated planning room and so forth.

It is necessary to operate a total website for the development consultation for experts, related data development articles and processing status Q&A and educational data, and to activate and process company chain store-based on/off line sale for every field or type of business. It is a global network design group system for a business cooperation and trading system for performing an architecture air view, an internal perspective view, etc. using a specialized computer and providing the results to architecture design offices. It is a global network office proxy group system for an office proxy execution office and associated office system for supporting the interior design and construction companies with design drawing business, such as an estimate, drawings and specifications, general management business, such as an office room, construction office business and so on.

It is a global network office proxy group system of an office proxy execution office and associated office system for supporting the building construction and construction companies with design drawing business, such as an estimate, drawings and specifications, general management business, such as an office room, construction office business and so on. It is a distribution sale and office proxy group system for performing design drawing business, general management business such as an office room, a construction office proxy task, the supply of materials, distribution, and general retail sale for the purpose of the interior design and the building construction companies and the architecture design offices.

It is a global network group system for auxiliarily developing and supporting several parts, such as design, materials, function teams, sale and management for improving environments of chain stores or affiliates and known medium and small-sized architectures and interior design companies. It is a group operation and global network group system for regional chain stores or direct management stores that perform various businesses of a global network group system base for auxiliarily developing and supporting several parts, such as design, materials, function teams, sale and management for improving environments of chain stores or affiliates and known medium and small-sized architectures and interior design companies, logistics, materials and product sale, and design, office proxy execution and product sale performed in each region.

It is a group operation and global network group system that constructs and operates regional production management and logistic center of each overseas country, and supplies them to each chain store. It is an Internet total site construction network operation that operates consultation, research, development, production, logistics, educational data, etc., which is integrally operated by experts and specialized companies in each field. It is a sale development and operation business-based global network that is activated on- and off-line for the sale of specialized company and specialized company groups on a field basis.

It is a sale development and sale operation business-based combined planning network group operation that is activated in on- and off-line manners and is needed for each field-based network group head office operation in each country. It is an Internet remote access business processing system global network group operation of a plan view and rendered view task of architecture design and interior design consisting designers of each country and lower worker system of a developing country.

Integrated Network Global Group Construction and Operation

In order to operate a company in a knowledge-based society that has an advanced and changed system having 50 times or more improved productivity of an industry society, the activation of an individual organization is required through advanced knowledge-based service supply and education so as to accomplish small-sized and company-based management, and talent evaluation management, and win-win team work management. A global network group that performs tasks generally exists at the center of the organization, and it must make a project, process the project and operate the project.

In order to change various media and small-sized companies to a large-sized company operation system in an era in which only large-sized companies in each country are advanced global multi-national companies, it is necessary to construct and operate a network group of a cooperation system based on various advanced operation organizations, management know-how, trading experiences in each country, company trading base and so on. In order to realize it, it is necessary to specialize fields, such as design business, material distribution, production companies, product development, construction method development, interior design and construction, sale, a designer integrated development group, the construction of an integrated group franchise, the construction of a specialized website and so forth, and to network-group them as a cooperation group. The training of competent persons, global group operation, etc. are the basis of an integrated network global group construction and operation through specialized growth of small-sized teams, the maximization of profits, and education to constituent members.

A company and network group that performs tasks on a field basis is constructed and operated.

1. Design Work Processing System Constructed Overseas

It is a special company that provides a plan view (a specialized business processing system of a 2D task, such as a CAD plan view and an elevation drawing), a rendered view (a high-quality rendering task solving and rapid system of 3D-MAX, a rendered view, etc.), and an architecture air view (an outside air view) without charge at the time of architecture design based on a multi-national integrated business processing system developed and constructed using Korea's IT solution and technology. A web produces and supplies various homepages, shopping malls, etc. without change. Computational business performs an estimate and the operation of a construction process management database program task at the lowest price.

2. Production, Logistics, Distribution and Management System of Architectural Materials, Furniture, Etc.

In a low unit cost supply system based on large quantity purchase and a worldwide product purchase and divided supply system, there are 1) a factory direct trading unit cost system in which purchase is performed on a group basis, 2) a rapid and cheap distribution system in which products are supplied on a region basis, 3) a direct operation system in which purchase, test and management are directly performed in respective countries, 4) an expert operation management and global operation system for materials in respective fields.

3. Various Material Development, Construction Method Development, and Construction Team Activation System.

Numerous companies are engaged in new product and design development, which are the life of an organization. 1) It is difficult to domestically obtain numerous new products from respective countries. This is because import companies prefer only popularized products on a large scale, and deal these products only. Therefore, common people cannot perform special or advanced design and education because they do not have information about new products.

2) Design can be used only when new products are known. Further, only when the design can be purchased at low cost, it can be applied to construction. A group supplies high quality products and the latest products inexpensively. 3) Development business is accompanied by lots of trial and error, huge economic investment and temporal loss in view of its characteristics. Only specialized persons who know this process can perform business cooperation with companies in a corresponding field smoothly.

4) It is a global group having special capability that can construct and realize the trading relationship with product production companies in each country rapidly, inexpensively and at good quality and can construct the reliability relationship between important customers, since it has development, production and distribution experiences several tens of years. 5) Since existing customers are secured in production areas in each country or a direct operation organization is active even in a new industrial complex, trial and error are less through the direct physical test and defect test of new products.

4. System for Providing Free Design Drawings (Drawing, Estimate and Specification) for Interior Design Construction Companies

1) Operation of a direct operation design company operation in developing country (China, Indonesia, Philippines, India, or . . . ), 2) Improved standardization productivity through the standard task of data for CAD task, 3) Construction of a specialized task and improved quality task system of 3D-rendered view and air view, 4) Construction of interior design specialized worker group system, 5) Free production and supply system through realization of low task unit cost

5. Free Computational Business Provision System for Interior Design Construction Companies

1) A consistent development and free-supply operation system for self-fabricated SI, ERP computational business programs, etc., 2) Education and activation supply system for computational business personnel (Set-up of IT research office), 3) Specially construction and supply of package program for construction companies

6. Sales Activation and Operation System Based on Integrated Network Group of Interior Design and Construction Companies

1) Supply of a business and operation environment activation system for medium and small-sized interior design construction companies, 2) Activation of sales in the name of each company, 3) Occupation and sale of an orderer by taking advantages of latest products and design and specialized construction team of new materials, 4) Maintenance of reliable relationship of consistent sale through integrated technology and specialized group system, 5) Large-sized organized and specialized group having large-sized company system in appearance and medium and small-sized company system based on rapid performance

7. Interior Design Conference and Designer Training System

1) Disclosure of design conception conference processing and result data of field-based practical personnel, 2) Activation of medium and small-sized company staff design education and construction practical education system, 3) Disclosure of data of technological conference with production factory development persons in charge, specialized technology and market trends, 4) Integrated material unit cost purchase of new designs of various products and materials, and the processing of divided supply and development in worldwide branch offices

8. Architecture Design Group System Based on Integrated Architecture Design Offices

1) Low price fabrication of cheap coloring finished air views and rendered view and supply of it to architecture design companies on a region or classification basis, 2) At the time of free supply of an architecture project draft design, free supply of outside color air view, 3) At the time of the practical design contract of an architecture, supply of internal rendered view, outside air view at cheap unit cost (10 to 20% or less cost), 4) Operation of integrated group sale system for architecture design company, building and construction company, interior design company and interior design company, 5) Sharing system for processing of large complex development, processing of various execution company, fund consulting, funding consultation

9. Free Design Cooperation and Computational Business Provision System for Architectural Construction Companies

1) Detailed design and coloring-finished practical drawing cooperation business system in association with each region and classification-based design office group, 2) System for Cooperation construction system with outside air view, internal color perspective view, indoor decoration, detailed design and interior design companies, 3) System for provision of process schedule, execution plan and enforcement table writing personnel and free computation business to small-sized construction companies, 4) Provision of computation system, such as architectural materials and materials input plan, transportation to site, excessive material conditions, etc., 5) Computation business management and free task system for input plan and daily enforcement report of subcontracting construction team.

10. Integrated Sale Activation and Operation System Based on Architectural Construction Companies

1) Management system in which an architecture design company, an interior design construction company, an article sale company and contents are integrally advertised along with the names of various construction companies, and the sale expenses are cheap despite large amount of advertising content, 2) Efficient sale operation system through specialized design in which various fields, such as housing, factory, building, garden and department store fields, are subdivided, and specialty depending on associated advertising classification sale and sale strategy processing of a construction companies is highlighted, 3) Loss is low when construction is performed in other areas because nationwide region-based companies have an associated system, 4) It is an operating system that has easy large project construction order reception, construction processing and rapid, reliable and integrated management.

11. Region-Based Associated Franchise Business System of proxy associated office works and sales store system, Such as Materials, Small Article Sale and Design, Office Business, Etc.

1) Franchise system in which materials sale and design, and office proxy execution business offices in each region are managed in a direct operation or chain store form, 2) Logistics supply operation system for sale at a regional chain store and direct operation business office, 3) Construction of operation management and education and evaluation system for regional chain stores and direct operation business offices, 4) Integrated coordination planning and operation management system for franchise head office operation and national franchise service system, such as design, products, management, sales, education, management, logistics, person affairs and general affairs.

12. Global business system for supplying product, Technology and Company Solutions Worldwide to Advanced Nations, Developing Countries, Etc.

1) Worldwide divided supply direct operation system for original products of each country, 2) Processing of development processing items in each field from the start to mass-production, 3) Field-based distribution-related industry sharing system for field-based technology and designs, such as architecture design, interior design and new method development, 4) member private education and sharing system for worldwide pertinent types of business of architecture interior and exterior decoration construction method and know-how, 5) Supply and management operation of medium and small-sized execution subcontracting team management and education system, 6) Construction of a material supply and distribution management computation business education and program for subcontracting construction teams, 7) Construction, supply and operation of design business task processing and settlement enforcement computation system between advanced nations and less advanced nations, 8) Operation of total website of each country's technology system, supply of data translation, and an integrated business processing, 9) Combined planning and operation system for performing and supplying an integrated network group business solution to each country, 10) Supply of a management system, such as business consulting, funding, investment recruiting, and operation and management of each field.

13. Collection Intellectual Total Website Operation System based on integrated data, such as various materials, Products, Development, Construction Methods, Construction Teams, construction companies, interior design, Architecture Design, It and Web Solutions, and in which Various Technology Companies and Technicians Exchange Opinions and Cooperate Each Other on a Web.

1) Web table and website part for various materials and products, and data and sale management that are operated by companies, 2) Web table and website part for web client data in which opinion about various materials and products are exchanged, 3) Website part for testing and evaluating practical education data of various technology students and assigning private qualifications and grades, 4) Integrated job offer and job hunting website part of various job-offer companies and job hunters, 5) Website part for various architecture design companies, building and construction companies, interior design companies and interior design companies, 6) Website part based on various small-sized construction team, 7) Personal introduction web table part for various personal construction functions, 8) Management of a country-based classification operation total website.

Various modifications, additions and substitutions can be made by those skilled in the art without departing from the scope and spirit of the invention as disclosed in the accompanying claims, so that the above-described invention is not limited to the above embodiment and the accompanying drawings.

### INDUSTRIAL APPLICABILITY

In order to simply construct a PC remote access control business processing system between a consultant PC and a client PC through an Internet-based remote control web server of the present invention and a global corporate organization utilizing a company system using the same, and to efficiently manage global business processing,

1. Knowledge-based value creation: In order for a company to succeed, it is necessary to increase added values of the company through the improvement of the business environment of the staff. An Internet PC remote-controlled business system is implemented so as to produce an efficient management system by combining a corporate organization business system with various techniques and experiences such as IT technology, information technology, computer graphics, SI and design. Thus, temporal and spatial business processing between a specialized company and experts can be improved and can be significantly developed to be a knowledge-based group organization.

2. Integrated technology implementation: Improvement of company values through the exchange of integrated techniques in various fields is the target of all companies. All business processes through a mutual remote business processing system between national and overseas companies at remote places, and companies that hold different specialized technologies can be performed using the Internet PC remote-controlled business system of the present invention. A business person in charge can directly connect a customer and a trading partner to a factory staff in real time, and can show and consult a progressing business processing situation and specialized technology contents to them.

3. Development-oriented management: Many companies and persons are concentrated on the development of new products, design, etc. This development business is accompanied by lots of trial and error, numerous economic and temporal losses in terms of its characteristics. In order to reduce such losses, tasks can be performed using the Internet PC remote-controlled business system of the present invention. Thus, there is an advantage in that a company management system of a development system business processing system that can supply refined and various designs and several product developments to customers and ordering entities within a short period of time and inexpensively.

4. Globalization construction through integrated variety: In an era in which the world becomes a single market, in a business environment in which a company can advance only when high value-added tasks, such as design, high-level product fabrication, etc. must be processed in an advanced nation itself and the production and supply of additional and typical products must be processed in developing countries, the Internet PC remote control business processing system of the present invention is necessary. The construction of a multi-national company and the processing of trading business can be performed through the construction and collection of an integrated business system, a trading system and an operating system in which the Kwangtung lighting complex, furniture complexes, architectural material industry cities in China, and the developing countries' industrial cities in Vietnam and Indonesia are interconnected and operated.

A global business processing system using the Internet PC remote control system and method of the present invention can be constructed as the PC remote control system and global business processing system of the present invention, in which Korea's Internet PC remote control system, a design-assistant business processing system that has been developed based on IT-utilizing techniques, various solution construction experience and company management know-how, company operation, trading experiences and progress capability that have been established at developing countries, an Internet computational system, such as ERP, etc. for construction sites and company management, and a production and logistics management system for materials, furniture, etc., are integrated.

1. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein the consultant PC first opens a consultant access administrator window of the PC remote control system, displays the consultant access administrator window on the monitor, and informs the client PC of a remote access request using a general telephone, so that the client PC is prompted to make access through a client adaptor or an access program through a website; and
wherein a client makes Internet remote control access by clicking on a client access menu of the Internet remote control system base at the client PC, and then the consultant PC remotely accesses the client PC and causes the client PC to remotely access the consultant PC by manipulating the PC main body of the client PC under remote control authority.

2. The integrated business processing system according to claim 1, wherein another consultant access administrator window installed at an Internet website, which is managed by a company of the consultant PC, is displayed on the monitor of the client PC through remote manipulation, and the consultant PC then accesses the client PC by clicking on client adaptors on the PC monitor.

3. The integrated business processing system according to claim 1, wherein client adaptor buttons installed at an Internet homepage for the Internet PC remote access are arranged, individual adaptor buttons classified on a region basis or a consultant basis are selected, and an individual classification symbol, name and contact number, etc. of a client are input.

4. The integrated business processing system according to claim 1, wherein the consultant PC is a task manager PC, a server PC and a main consultant PC, the client PC is a customer PC and a client PC, and the consultant PC is a worker PC.

5. The integrated business processing system according to claim 1, wherein a remote control access screen of the client PC is moved to the auxiliary monitor of the consultant PC, other than the main monitor, any one of the main monitor and the auxiliary monitors of the consultant PC is constructed as a liquid crystal tablet having a tablet function, or an additional tablet or pen mouse is connected to the PC main body to perform bidirectional writing and drawing functions.

6. The integrated business processing system according to claim 5, wherein, if remote control database coding is set in the client adaptor menu so that a subsequent operation function can be automatically operated—an operation function of another consultant access administrator window displayed on the monitor of the client PC main body through remote control manipulation by the consultant PC—when the client PC is accessed through Internet remote control by clicking on the client adaptor menu, two-step Internet remote control access is further included.

7. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein the client PC has an auxiliary monitor, a main monitor and a tablet function device constructed in a PC main body, the consultant worker PC accesses the bidirectional remote control system by constructing the monitor of the PC main body and the tablet function device, and in the PC main body of the client PC, as a monitor or tablet function device of the PC main body is remotely connected to the bidirectional remote control system through the auxiliary monitor in the consultant worker PC, the monitor or the tablet function device is remotely connected to the main monitor.

8. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein an auxiliary monitor, a main monitor and a tablet function device are constructed in a PC main body of the client PC, a monitor of the PC main body and a tablet function device are constructed in the consultant worker PC, the consultant worker PC accesses the bidirectional remote control system, and in the PC main body of the client PC in which the tablet function device is installed, as the monitor or the tablet function device of the PC main body is remotely connected to the bidirectional remote control system in a consultant worker PC 1 or 3 through the auxiliary monitor, the auxiliary monitor or the multi-monitor is remotely connected to the main monitor.

9. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein the main monitor connected to the PC main body of the worker PC is remotely connected to the main monitor connected to the PC main body of the client PC, the main monitor connected to the PC main body is remotely connected to the main monitor connected to the PC main body of the worker PC that performs a task using a computer program, the consultant PC is connected to the client PC and remotely controls the client PC main body and the main monitor to access the PC main body of the worker PC under remote control authority; and
wherein the auxiliary monitor or the multi-monitor connected to the PC main body of the worker PC is remotely connected to the auxiliary monitor or the multi-monitor of the consultant PC main body, and the consultant PC and the worker PC that performs a task using a computer are remotely connected through a consultant administrator access window for remote access and means of a client access program button.

10. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein the consultant PC first displays a remote access consultant administrator access window installed on a website on the main monitor connected to the PC main body, inputs a password, and waits, and the client PC or the worker PC is remotely connected through a client remote access button or using a client access program, in a state where a third party is connected, the consultant PC shows a worker PC screen that is being performed to the client PC using a screen send function, or shows a worker PC screen that is being performed on a worker PC screen that performs a task using the client PC in a reverse direction.

11. The integrated business processing system according to claim 9, wherein the access window is installed at a web table on the Internet website in the consultant PC for PC remote connection, which can remotely control a counterpart PC under remote control authority in the Internet web server-based PC remote control access system.

12. The integrated business processing system according to claim 10, wherein the client PC first opens the remote access consultant access window, and the consultant PC is then remotely connected to the remote access client.

13. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a writing and drawing function device is added to a unidirectional access control method in which the consultant PC opens a consultant administrator access window, remotely connects to and opens the client PC, and then performs consultation and business processes;
wherein a client PC office is a counterpart, an agency, other business processing sides, a customer, a member, a chain store and an affiliated firm, and a consultant PC office is a main consultant PC and an upper-level person-in-charge PC in terms of business processing; and wherein a telephone, a liquid crystal tablet, a printer, a scanner, an assistant consultant who visits the client PC and gives consultation, portable and supplementary equipment, and a conference call function telephone and speakerphone are installed in each office room.

14. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a client PC office including the client PC of the PC remote control business processing system, a telephone, a printer for computer data output, and a scanner connected to a computer, a web server consultant PC for a major task manager of a PC remote control business processing system, a computer worker PC of a main consultant, a consultant server PC office including a liquid crystal tablet connected to the PC and configured to implement writing and drawing functions unidirectionally or bidirectionally, a conference call and speakerphone function telephone, a general telephone, and a printer and scanner for a computer, and an Internet web server used to store or exchange task data for a computer are included;
if the client PC opens a homepage, etc. on the Internet and subscribes to the unidirectional PC remote control web server by inputting a user ID registered with a web server for PC remote control, a web server consultant PC for a main consultant is remotely connected to the client PC, and if a server consultant PC remotely controls the client PC to access a worker PC that has been previously registered with the remote control web server under remote control authority, the client PC office and the consultant PC office are connected bidirectionally.

15. The integrated business processing system according to claim 14, wherein:
a PC for a computer worker in the consultant server PC office is constructed as an independent worker PC office, and performs various tasks at a remote place, the main consultant PC office is a main consultant PC and an upper-level person-in-charge PC in terms of business processing, and the worker PC office is a task administrator PC and a PC that performs tasks using various programs.

16. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a consultant server PC, a worker PC and a plurality of client offices are constructed within a web server consultant office room for a main task manager; and
wherein the client PCs are multi-connected to a consultant PC 1 in which a lecturer who gives a lecture through remote control exists and views lecture contents for motion image or other educational data, the worker PC in which the lecturer exists are remotely multi-connected to the respective client PCs, monitor situations of upper client PCs are displayed on the monitor of the worker PC, and at the time of an individual question and response, one to one separated situation is produced to perform separation consultation and business individually.

17. An integrated business processing system, using a bidirectional PC remote control base in which a client Personal Computer (PC) of an Internet PC remote control system, including a PC main body and a general monitor connected to the PC main body, and a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a writing and drawing function device is additionally installed at a unidirectional access control method in which the consultant PC opens a consultant administrator access window, and the client PC is remotely connected and opened and then performs consultation and business processes, and a telephone, a liquid crystal tablet, a printer, a scanner, an assistant consultant who visits the client PC and gives consultation, portable and supplementary equipment, and a conference call phone and speakerphone are installed in each office room; and
wherein a main task administrator PC and a lower worker side PC are connected on the major task manager office room side.

18. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port:
wherein a 1:1 unidirectional PC remote control business processing system is constructed between a client PC office room and a consultant PC office; and
wherein a construction estimate consultant dispatched from a consultant office room or a company visits the client PC office while carrying a portable notebook PC terminal, a liquid crystal tablet and a third party or more conference call telephone.

19. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a writing and drawing function device is additionally installed at a unidirectional access control method in which the consultant PC opens a consultant administrator access window, and the client PC is remotely connected and opened and then performs consultation and business processes, and a telephone, a liquid crystal tablet, a printer, a scanner, an assistant consultant who visits the client PC and gives consultation, portable and supplementary equipment, and a conference call telephone and speakerphone are installed in each office room; and
wherein a client PC system in which an affiliate, a common customer, a customer, etc. comprise a client PC office and a plurality of office rooms,
a consultant PC system in which a chain store, an agency, an affiliated firm, a SOHO chain store, etc. comprise a web hard used for a main consultant PC office and agency-based web homepage and business,
a head office system comprising an upper ask manager, a worker PC office and a head office homepage, that is, a combined total website, and a web hard, and
a business auxiliary worker PC system comprising a lower-level task administrator and a business auxiliary worker office in which business of a head office system is solved auxiliarily are included.

20. The integrated business processing system according to claim 19, wherein in the case where an integrated business processing service is performed, a construction-site business processing PC system in which construction site PC offices in addition to a client PC system, a consultant server PC system and a head office system are additionally connected using as business processing system is constructed in a construction industry; and
a material and distribution system comprising production company and sales store PC offices of material articles; and a custom-built and material development system comprising custom-built or development company PC offices in which the PC remote control business processing system is utilized on a custom-built or development company side of materials or articles consumed at a site construction, are integrally constructed.

21. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a writing and drawing function device is additionally installed at a unidirectional access control method in which the consultant PC opens a consultant administrator access window, and the client PC is remotely connected and opened and then performs consultation and business processes, and a telephone, a liquid crystal tablet, a printer, a scanner, an assistant consultant who visits the client PC and gives consultation, portable and supplementary equipment, and a conference call telephone and speakerphone are installed in each office room; and
wherein, in the case of a business processing of a corporate organization, a company head office warehouse and factory system comprising manufacturing factory PC offices and distribution warehouse PC offices utilizing the PC remote-controlled business processing system in addition to a client PC system, a consultant server PC system and a head office system, and developing country production factory and import person-in-charge systems comprising production factory PC offices utilizing the PC remote control business processing system at a developing country and import manager side PC offices that import articles are integrally constructed.

22. An integrated business processing system, using a bidirectional PC remote control base in which a client Personal Computer (PC) of an Internet PC remote control system, including a PC main body and a general monitor connected to the PC main body, a consultant PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, a worker PC of the Internet PC remote control system, including a PC main body and multiple monitors composed of a main monitor and an auxiliary monitor implemented using a liquid crystal tablet or a general tablet, the monitors being connected to the PC main body and being capable of performing two or more writing and drawing functions, are connected via communication means for an wired/wireless or satellite Internet, and a remote control client module, a remote FIP client module and a remote CHAT client module are constructed for the remote control, and are adapted to analyze corresponding protocols and distribute and transmit respective threads through a TCP/IP communication port;
wherein a writing and drawing function device is added to a unidirectional access control method in which the consultant PC opens a consultant administrator access window, remotely connects to and opens the client PC and then performs consultation and business processes, and a telephone, a liquid crystal tablet, a printer, a scanner, an assistant consultant who visits the client PC and gives consultation, portable and supplementary equipment, and a conference call telephone and speakerphone are installed in each office room;
a construction of an Internet web server of a system operated within a single country of constructions of a company business processing system, an Internet web server of a remote control system, a field-based head office homepage, etc., and
a construction of global standard businesses operated at a global group head office that integrally supports head offices of PC remote control-based integrated business processing system operation companies distributed in respective countries, web shopping mall fabrication and operation data construction, symbol and data standardization business material system, symbol and data standardization business of various design systems, data standardization business of various product systems, data standardization business of various businesses management systems, standardization business of various commercial field-based planning systems, and other businesses are included.

23. The integrated business processing system according to claim 10, wherein the access window is installed at a web table on the Internet website in the consultant PC for PC remote connection, which can remotely control a counterpart PC under remote control authority in the Internet web server-based PC remote control access system.
